(19) United States
(12) Patent Application Publication
(10) Pub. No.: US 2018/0220506 A1
(43) Pub. Date: Aug. 2, 2018

(54) Solid State Luminaire Lighting System

(71) Applicant: Laurence P. Sadwick, Salt Lake City, UT (US)

(72) Inventor: Laurence P. Sadwick, Salt Lake City, UT (US)

(21) Appl. No.: 15/885,788

(22) Filed: Jan. 31, 2018

Related U.S. Application Data
(60) Provisional application No. 62/452,971, filed on Jan. 31, 2017.

(51) Int. Cl. H05B 33/08; F21K 9/275; F21V 17/10

(52) U.S. Cl. CPC H05B 33/0854; F21K 9/275; F21Y 2115/10; F21V 17/101; F21V 17/10

(57) ABSTRACT

A lighting system includes a solid state luminaire configured to be mounted to provide task lighting to at least one area, a user interface configured to accept lighting settings for the lighting system, and a user interface configured to enable at least one of the solid state luminaire and an area light source to be controlled to provide a desired illumination level to a workspace, wherein the solid state luminaire and the area light source both illuminate the workspace.

### BACKGROUND

Lighting systems are often designed based on the overall space to be lit, for example determining the number of fluorescent lamp fixtures in ceiling mounted linear troffers to install in a building or work area in order to sufficiently light the space in general. In a work environment filled with cubicles surrounding desks or work spaces, this lighting design generally is not performed based on the ultimate placement and layout of cubicles and work spaces, which can be changed and rearranged based on the needs of the business. Furthermore, control of the lighting in such a space is generally not provided based on individual needs, but on the operating schedule of the business. For example, all the fluorescent ceiling mounted light fixtures might be programmable as a group to turn on shortly before the time that workers are scheduled to arrive and to turn off shortly after workers are scheduled to leave. If some ability is provided to override that schedule, it typically allows lights for the entire space to be turned on earlier than scheduled or to remain on as a group later than scheduled.

Such space-based lighting design can simplify the initial construction of a building, but is energy inefficient, is not likely to meet the individual needs of workers, and is not customizable to meet the needs of the users of the space. Ceiling distances (often two to three times higher than cubical walls) require higher wattages to achieve the same light intensity compared to a light source placed closer to the work surface, and not all light is useful and efficient. Ceiling fixtures also require expensive equipment and talent to install and maintain. Individuals often resort to the use of lamps which can be left on after hours, wasting electricity and posing risk from an ill-maintained assortment of personal lighting lamps and related appliances which may have, for example, been rejected from home use.

### SUMMARY

The present invention provides solid-state lighting or other lighting including personalized work surface illumination. In some embodiments, personalized work surface solid-state lighting systems or other lighting systems can be mounted on cubicle or similar types of walls or even the walls themselves to controllably illuminate adjacent or nearby work surfaces. In some embodiments, illumination can be configured and controlled in conjunction with or at least partially based on illumination from other sources. In some embodiments, the personalized work surface solid-state or other lighting systems can be controllably dimmed, trimmed, color-temperature-tuned, color-tuned, full-spectrum-tuned, etc., combinations of these, etc. In some embodiments, the personalized work surface solid-state lighting or other lighting systems can be controlled in part based on motion sensors and/or other sensors, including but not limited to photo and/or ambient light sensors for example to reduce energy usage in unoccupied spaces.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 is a diagram of a personalized direct work surface illumination system with gap adjustment for ceiling illumination in accordance with some embodiments of the invention.

FIG. 2 is a diagram of an indirect ceiling illumination system in accordance with some embodiments of the invention.

FIG. 3 is a diagram of a cubicle wall-top mounted personalized illumination system in accordance with some embodiments of the invention.

FIG. 4 is a diagram of the cubicle wall-top-mounted personalized illumination system of FIG. 3 which can be controlled based at least in part on or in coordination with ceiling-mounted illumination in accordance with some embodiments of the invention.

FIG. 5 is a diagram depicting vertical illumination control in a system including cubicle wall-top-mounted personalized illumination and ceiling-mounted illumination in accordance with some embodiments of the invention.

FIG. 6 is a diagram depicting hypotenuse illumination control in a system including cubicle wall-top mounted personalized illumination and ceiling mounted illumination in accordance with some embodiments of the invention.

FIG. 7 depicts a top view of a cubicle office space with a personalized direct work surface illumination system in accordance with some embodiments of the invention.

FIG. 8 depicts an example user interface for configuration of a personalized direct work surface illumination system in accordance with some embodiments of the invention.

FIG. 9 depicts a foldable personalized illumination system in a folded light-source protecting configuration in accordance with some embodiments of the invention.

FIG. 10 depicts a foldable personalized illumination system in an unfolded operating configuration providing both direct work surface illumination and indirect ceiling illumination in accordance with some embodiments of the invention.

FIG. 11 depicts a personalized illumination system providing both direct work surface illumination and indirect ceiling illumination including curved base and optional diffuser in accordance with some embodiments of the invention.

FIG. 12 depicts a wider personalized illumination system providing both direct work surface illumination and indirect ceiling illumination including curved base and optional diffuser in accordance with some embodiments of the invention.

FIG. 13 depicts a suspended personalized direct work surface illumination system including curved base and diffuser in accordance with some embodiments of the invention.

FIG. 14 depicts a side view of the personalized direct work surface illumination system of FIG. 13 in accordance with some embodiments of the invention.

FIG. 15 depicts a suspended curved panel-based personalized direct work surface illumination system including curved base and suspension diffuser in accordance with some embodiments of the invention.

FIG. 16 depicts a side view of the personalized direct work surface illumination system of FIG. 15 in accordance with some embodiments of the invention.

FIG. 17 depicts a personalized direct reflected work surface illumination system with two-sided reflector in accordance with some embodiments of the invention.

FIG. 18 depicts a personalized illumination system providing both direct work surface illumination and indirect ceiling illumination including curved reflector in accordance with some embodiments of the invention.

FIG. 19 depicts a personalized direct work surface illumination system with straight double reflectors in accordance with some embodiments of the invention.

FIG. 20 depicts a personalized illumination system providing both direct work surface illumination and indirect ceiling illumination with straight diffusers in accordance with some embodiments of the invention.

FIG. 21 depicts a personalized direct work surface illumination system with multi-faceted base with straight and curved diffusers in accordance with some embodiments of the invention.

FIG. 22 depicts a personalized illumination system providing both direct work surface illumination and indirect ceiling illumination with straight and curved diffusers in accordance with some embodiments of the invention.

FIG. 23 depicts a personalized illumination system providing both direct work surface illumination and indirect ceiling illumination with adjustable wings and diffuser with point light sources or panel light sources in accordance with some embodiments of the invention.

FIG. 24 depicts a thin edge-lit personalized illumination system providing both direct work surface illumination and indirect ceiling illumination with adjustable wings in accordance with some embodiments of the invention.

FIG. 25 depicts a cubicle wall-mounted cabinet with a personalized illumination system in accordance with some embodiments of the invention.

FIG. 26 depicts a personalized illumination system with optional glare deflectors and diffusers in accordance with some embodiments of the invention.

FIG. 27 depicts an example floorplan of a building with a personalized illumination system in accordance with some embodiments of the invention.

FIG. 28 depicts a block diagram of a personalized illumination system in accordance with some embodiments of the invention.

FIG. 29 depicts a block diagram of a personalized illumination system in accordance with some embodiments of the invention.

FIG. 30 depicts a block diagram of a personalized illumination system in accordance with some embodiments of the invention.

FIG. 31 depicts a solid state replacement for a fluorescent lamp, with an external motion, light, or color sensor or other device in accordance with some embodiments of the invention.

FIG. 32 depicts a solid state replacement for a fluorescent lamp, with an external electronic device powered by the solid state lamp replacement in accordance with some embodiments of the invention.

FIG. 33 depicts a side view of three example mounting clips for mounting a diffuser to a solid state lamp replacement in accordance with some embodiments of the invention.

FIG. 34 depicts the three mounting clips of FIG. 33, with a bottom view of one of the clips.

FIG. 35 depicts a fluorescent lamp fixture with three example mounting clips connected to a solid state lamp replacement, before attaching a diffuser to the clips, in accordance with some embodiments of the invention.

FIG. 36 depicts a fluorescent lamp fixture with an example diffuser mounted to a solid state lamp replacement with a number of clips in accordance with some embodiments of the invention.

FIG. 37 depicts a fluorescent lamp fixture with another example diffuser mounted to a solid state lamp replacement with a number of clips in accordance with some embodiments of the invention.

FIG. 38 depicts a fluorescent lamp fixture with another example diffuser mounted to a solid state lamp replacement with a number of clips in accordance with some embodiments of the invention.

FIG. 39 depicts a side view of a cubicle or other partial wall with a solid state luminaire in accordance with some embodiments of the invention.

FIG. 40 depicts a top view of a cubicle office space with a personalized direct work surface illumination system and with a ceiling mounted fluorescent lamp fixture with optional solid state lamp replacements in accordance with some embodiments of the invention.

FIG. 41A depicts an end view of a cubicle or other partial wall with a solid state luminaire providing task lighting to work spaces on either side of the wall in accordance with some embodiments of the invention.

FIG. 41B depicts an end view of a cubicle or other partial wall with a solid state luminaire providing task lighting to a work space on one side of the wall and to a hallway or other area on the other side of the wall in accordance with some embodiments of the invention.

FIG. 42 depicts a personalized illumination system providing both direct work surface illumination and indirect ceiling illumination in accordance with some embodiments of the invention.

FIG. 43 depicts an end view of one or more personalized illumination systems mounted at various possible and example points on a wall or mounting surface, illustrating illumination at various locations in accordance with some embodiments of the invention.

### DETAILED DESCRIPTION OF THE INVENTION

Personalized solid-state lighting or other types of lighting systems are disclosed herein which provide efficient, modular, highly configurable and customizable lighting for both work surface and area lighting. In some embodiments, personalized solid-state lighting or other lighting systems comprise luminaires that can be mounted atop cubicle walls to illuminate desktops or other work surfaces and, if desired, to provide indirect area lighting, using solid-state light sources or other light sources such as, but not limited to, light-emitting diodes (LEDs), organic light-emitting diode (OLEDs) and/or quantum dot (QD) or other solid-state lamps and, in certain embodiments, other types of lighting sources and/or lamps including incandescent, florescent, halogen, etc., which can be combined with reflectors, diffusers, edge-lit panels, light pipes, side-lit panels, fiber optics, etc., and/or other light dispersal and direction systems as well as combinations of these, etc.

The personalized lighting systems can be configured for modular installation with customizable options such as, but not limited to, strip length, wattage, LED efficiency, color temperature(s), one or more colors/wavelengths/primary wavelengths, etc., energy tracking, sensor-based control, section hierarchy, wired/wireless control connection type, etc. This enables users to simply install lighting to directly meet their individual needs requires, or wants, etc., even in a cubicle-based work environment, with both individual and overall control supported. By including sensors such as motion detectors mounted near the lighting system, such as on cubicle walls, on or under desks, etc., personalized lighting systems can be configured to dim and/or to turn off when the associated space is unoccupied, such as turning off the work surface lighting in a particular cubicle when no motion has been detected in that cubicle for a particular period of time. Dimming levels and/or color or color temperature, including full spectrum lighting, can also be individually controlled in some embodiments. In some cases, light strips or modules in the system can be configured with different hierarchy levels, enabling a leader module to pass along configuration settings to follower modules and/or allowing parallel or series or combinations of parallel/series configurations, and/or allowing a leader module to control or interact with ceiling-based lighting to provide the desired lighting at a given time; for example, but not limited to, more light in the cubicle space and less light in the ceiling or other ambient light systems such as but not limited to cove, accent, sconce, general wall fixtures, suspended fixtures, downlights, can lights, track lights, other decorative and/or functional lights, etc. and alter or reverse the situation when the cubicles are unoccupied or one or more people are in the process of moving from the cubicle(s) to the general or common surrounding areas in which case, the cubicle(s) lighting and other electrical and HVAC can be dimmed, reduced, turned off, etc., combinations of these, etc. In some embodiments of the present invention, the ceiling lights can two-way communicate with the present invention including but not limited to the sensors of the present invention to respond to the present invention including but not limited to dimming up or down in a prescribed manner including dimming smoothly over a certain amount of time in certain scenarios and including but not limited to turning full on in safety or emergency related situations. In a like-wise fashion, other lights including both interior/inside and exterior/outside lights could respond in similar, appropriate, etc. ways and operations, etc.

In some embodiments, the personalized lighting systems disclosed herein provide a substantial wattage reduction using a shorter length and/or lower wattage of, for example but not limited to, solid-state lighting strips, strings, tubes, etc. than even solid-state lighting or other lighting type ceiling lighting fixtures due in part to the closer proximity to the work surface. Applying, for example, but not limited to, the inverse square law for a point light source, installing the personalized lighting system at half the distance to the work surface from a ceiling light can require only one-fourth the luminosity and potentially save up to 87.5% in energy on that basis alone. Furthermore, the personalized lighting systems disclosed herein provide personalized control over one's lighting environment, such as, but not limited to, digital dimming level, white color temperature tunability, full-spectrum color tunability, light direction, trimming including maximum and minimum trimming, scheduling, and sensor thresholds (daylight & occupancy). This can serve to improve adoption of solid-state lighting or other lighting and allow adapting to occupant types and preferences for, as examples, improved productivity, human reaction, or appeal of the space. The personalized lighting systems can be quickly installed by non-electrical personnel, without requiring complex/expensive ceiling wiring, and can be used in both new and old construction. In some embodiments, one or more strips of the personalized lighting systems can be plugged into common receptacles and share power with connected strips. It also supports greater flexibility in office arrangements, allowing cubicles and desks to be placed as desired rather than having to position them under installed ceiling lighting or sharing the ceiling lighting among more than one person/occupant. The ability to not need to share lighting and to also provide additional features including customization of lighting color temperature, colors, patterns, lighting combinations and intensity, lighting monitoring, energy savings, occupancy detection and determination, as well as HVAC monitoring and choices including but not limited to comfort choices, temperature, humidity, air quality, etc., can provide for a significantly enhanced environment including but not limited to positive physical and mental attributes including but not limited to productivity, happiness, general well being, improved health, less fatigue, and potentially decreased frequency and reduced severity of human resource (HR) conflicts, issues, and other negative interactions.

The personalized lighting systems can also provide a vast array of options while being manufactured using flexible, intelligent just-in-time manufacturing, thereby increasing adoption of efficient solid-state lighting or other lighting and assisting in the move away from less-efficient linear fluorescent lamps or from linear lamps as a whole in cubicle or other spaces. Cubicle height and barriers enable lower-wattage lighting that produces a higher percentage of useful light. The inherent space segmentation also enables more efficient sensor integration.

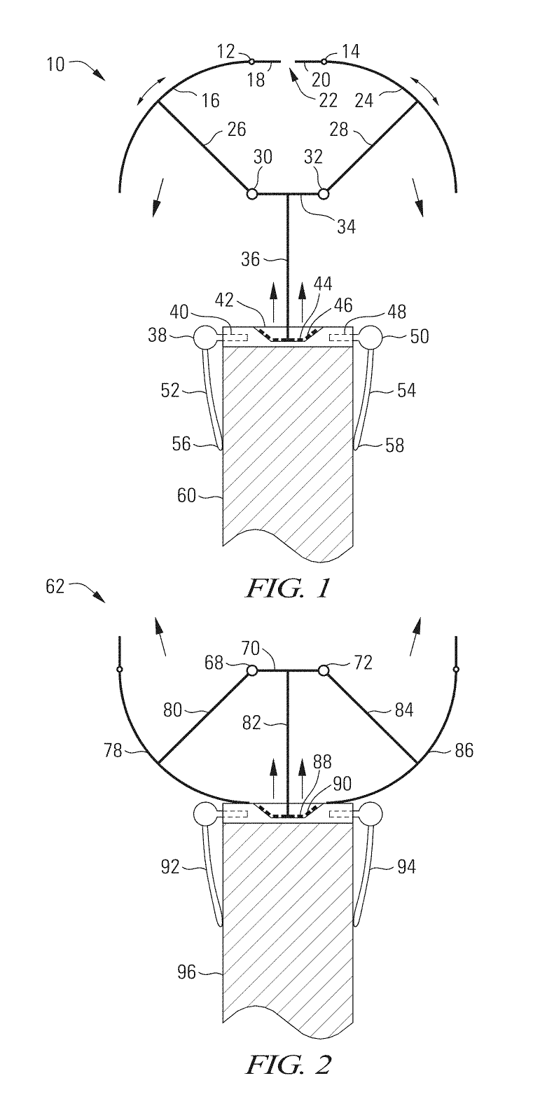

Turning now to FIG. 1, a cubicle-top-mounted personalized direct work surface lighting system 10 is depicted in accordance with some embodiments of the invention. The lighting system 10 includes a number of solid-state lights (e.g., 44, 46), such as, but not limited to, light-emitting diodes (LEDs), organic LEDs (OLEDs), quantum dot (QD) or other solid-state point light sources or other light source, or even panel light sources such as, but not limited to, organic light-emitting diode (OLEDs) or LED edge-lit panels. Although a number of light sources (e.g., 44, 46) are depicted in FIG. 1, the light sources are not each individually called out with element numbers in FIG. 1 and other Figures to preserve clarity in the drawings.

The lighting system 10 is configured to be mounted along, for example but not limited to, the top of a cubicle wall 60, and can be attached, for example but not limited to, using clamps 52, 54, which in some cases are adjustable based on the width of the cubicle wall 60. For example, in some cases clamps 52, 54 include mounting pins 40, 48 which extend into holes in the mounting body of the lighting system 10, and the depth at which the mounting pins 40, 48 extend into holes in the mounting body is adjusted based on the width of the cubicle wall 60, so that clamp arms 56, 58 are pressed against the cubicle wall 60 to maintain the position and orientation of the lighting system 10. The clamps 52, 54 can be formed as holdfasts or doglegs, acting as spring clamps with tension from the cubicle wall 60 pressing the mounting pins 40, 48 and clamp arms 56, 58 apart as they are held together by clamp body 38, 50. However, the lighting system 10 is not limited to use with any particular type of clamp or mounting system, and can also be mounted using adhesives, whether removable or permanent, screws or other fasteners, magnets, snaps, slides, etc. Clamps can be adjustable or fixed width, and can be permanently or removably affixed to the mounting body of the lighting system 10 or at any location of the lighting system 10, and can be adjustable or can have a fixed width. In some embodiments of the present invention, the walls of the cubicles or other surfaces on the cubicles or even objects inside of the cubicles or attached to the cubicles, for example but not limited to, the vertical wall surfaces of the cubicle walls or the shelfs or cabinets attached to the cubicles can also be used or be used instead of only the top of the cubicles. Based upon the disclosure provided herein, one of ordinary skill in the art will recognize a variety of mounting hardware that can be used to affix the lighting system 10 to any desired mounting surface. Furthermore, the lighting system 10 is not limited to use on cubicle walls, but can be mounted to any surface so that the illumination is oriented toward the area to be lighted including but not limited to walls including but not limited to cubicle or other walls, shelves, under shelves, vertical and/or horizontal surfaces of shelves, cabinets, desks, file cabinets, etc., combinations of these, etc.

In this example embodiment, the solid-state lights or other light source (e.g., 44, 46) are mounted in a concave receptacle in the mounting body of the lighting system 10, and can be oriented in one or more directions, such as the vertical and angled illumination directions illustrated in FIG. 1. In some cases, the substrate on which the solid-state lights or other light source (e.g., 44, 46) are mounted can be partially or entirely covered in a reflective material to assist in directing as much of the usable light along the desired path as possible. In some cases, a diffuser 42 or other protective covering can be provided over the solid-state lights or other light source (e.g., 44, 46), protecting the solid-state lights or other light source (e.g., 44, 46) and optionally diffusing the light from the point light sources.

One or more attachment rods (e.g., 36, 34, 26, 28), panels, or other structures can be used to support reflectors (e.g., 16, 24) to redirect the light from the solid-state lights or other light source (e.g., 44, 46) down to work surfaces. For example, rods 36, 34, 26, 28 can be plastic or metal or any other suitable material, formed in cylinders, squares, rectangles, stars, or any other suitable shape, and can connect to the mounting body of the lighting system 10 and to the reflectors (e.g., 16, 24) in any suitable manner, such as in mounting holes or brackets. In some cases, some of the support structures (e.g., 36) can be solid panels to allow one side of the cubicle wall 60 to be illuminated without illuminating the other side, for example, allowing light to reach reflector 16 but not reflector 24. In such cases, the support structure (e.g., 36) can also be reflective, redirecting the light from the solid-state lights or other light source (e.g., 44, 46) to a work surface or other area to be illuminated adjacent the cubicle wall 60.

In this example embodiment, the reflectors 16, 24 are curved, allowing the light to be focused or narrowed onto the work surface(s). Hinges or pivots (e.g., 30, 32) can be provided in the support structures to allow the reflectors 16, 24 to be pivoted to direct the reflected light as desired.

In some embodiments, such as but not limited to that depicted in FIG. 1, the personalized lighting system 10 can be configured to provide both direct work surface lighting, with solid-state lights or other light source (e.g., 44, 46) directed by reflectors 16, 24 directly onto the work surface, and indirect lighting by illuminating the ceiling. For example, a gap 22 can be adjusted through which light from the lights (e.g., 44, 46) can pass up toward the ceiling to provide indirect lighting. Adjustable panels 18, 20 can be angled, pivoted, rotated, slid back, etc. using pivots (e.g., 12, 14) or other adjustable mounting hardware such as, but not limited to, slides, etc.

Turning now to FIG. 2, a lighting system such as that 10 in FIG. 1 can in some cases be reoriented to provide indirect ceiling lighting, such as in the indirect ceiling lighting system 62 depicted in FIG. 2 in accordance with some embodiments of the invention. The lighting system 62 can be mounted to a cubicle wall 96 or any other suitable mounting surface, for example, but not limited to, using a fixed or variable-width clamping mechanism 92, 94.

One or more solid-state lights or other light source (e.g., 88, 90) are mounted in the main body of the lighting system 62, for example but not limited to mounting them in a concave receptacle with or without a protective cover, and with or without a reflective substrate under or around the solid-state lights or other light source (e.g., 88, 90).

In this embodiment, curved reflectors 78, 86 mounted on pivots 68, 72 through support structure 82, 70, 80, 84 have been pivoted down, blocking direct illumination of any work surfaces adjacent cubicle wall 96, and causing the light from solid-state lights or other light source (e.g., 88, 90) to be directed upward toward the ceiling.

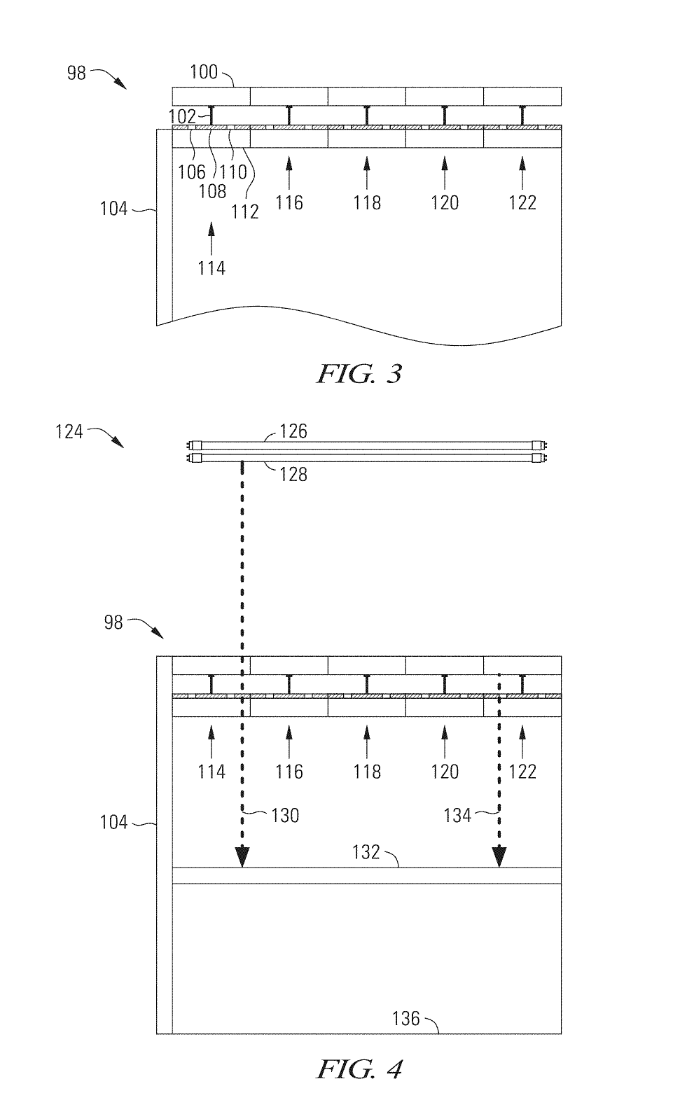

Turning to FIG. 3, a side view of a personalized lighting system 98 is depicted, mounted atop a cubicle wall 104, in accordance with some embodiments of the invention. The main body 108 of the lighting system 98 is mounted on the cubicle wall 104, for example by clamps that can comprise, for example but not limited to, one or more clamp bodies 106, 110 and clamp arms (e.g., 112). The clamp arms can extend the length of each module or strip (e.g., 114), or can comprise one or more narrower clamp members. Reflectors (e.g., 100) can be mounted on support structures (e.g., 102). Multiple lighting modules or strips 114, 116, 118, 120, 122 can be interconnected, optionally sharing power and configuration settings. For example, one of the modules (e.g., 114) can be configured as a leader and the other modules 116, 118, 120, 122 as followers in a configuration hierarchy, so that as the leader module 114 is configured, it passes the settings to the follower modules 116, 118, 120, 122. Such settings can include, but are not limited to, one or more of the following: on/off state, dimming level, color, color temperature, lighting group association, sensor information, etc.

As shown in FIG. 4, the personalized lighting system 98 can be configured to operate in conjunction with other lighting, such as ceiling mounted lighting, whether fluorescent lamps in ceiling mounted linear troffers or linear solid-state lights 126, 128, such as LED replacements that fit into existing fluorescent fixtures or other lighting. Such ceiling mounted lighting can comprise systems such as those disclosed in PCT patent applications PCT/US16/45659 filed Aug. 4, 2016 for “Solid State Lighting Systems”, and PCT/US16/52560 filed Sep. 19, 2016 for “Solid State Lighting Systems”, which are incorporated herein by reference for all purposes.

The illumination levels from the personalized lighting system 98 can be configured at least in part on the illumination 130 from the ceiling mounted lights 126, 128 on the work surface 132 so that the illumination 134 from the ceiling mounted lights 126, 128, combined with the illumination from the personalized lighting system 98, provides the total desired amount of illumination on the work surface 132. Although the ceiling mounted lights 126, 128 may be configured generally to illuminate an entire room from ceiling to floor 136, it may contribute some but not all of the desired illumination level on a specific work surface 132. The personalized lighting system 98 can thus be configured in some embodiments to provide the desired illumination of the work surface 132, without excessive illumination or wasted power when ceiling mounted lights 126, 128 are also present.

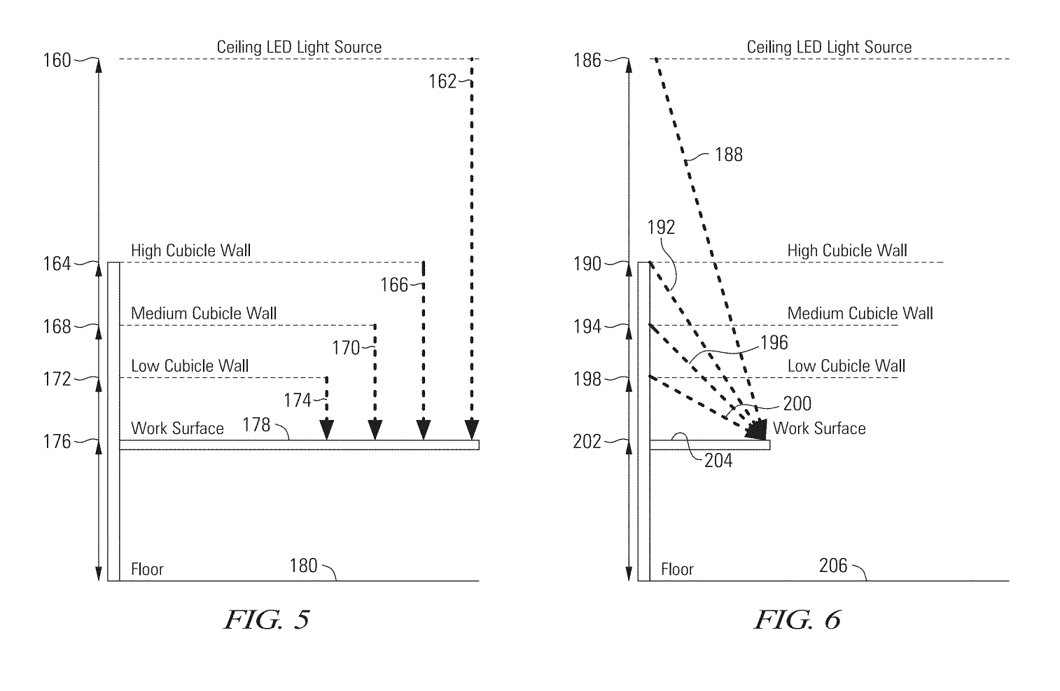

Several examples of such combined source configuration are depicted in FIGS. 5 and 6. Turning to FIG. 5, vertical illumination control of a personalized lighting system is depicted in accordance with some embodiments of the invention, where both a personalized lighting system and ceiling mounted lighting are present. Based in part on the height 160 of ceiling mounted lighting, the illumination 162 from the ceiling mounted lighting can vary and may not be sufficient to light the work surface 78. The illumination level from a personalized lighting system mounted on a cubicle wall can be adjusted based on preference, requirement, etc. and/or the height of the cubicle wall, in conjunction with the illumination level from the ceiling mounted lighting, to provide the desired illumination of the work surface 178.

FIG. 5 shows how the personalized lighting system reduces energy consumption through closer proximity to the work surface while at the same time increasing individual control over the lit environment. In one non-limiting, purely illustrative example in FIG. 5 (showing orthogonal illumination), if the ceiling mounted lighting is at a height 160 of 108 inches from the floor 180, with the work surface 178 at a height 176 of 29 inches from the floor 180, and the personalized lighting system is mounted on a high cubicle wall at a height 164 of 66 inches from the floor 180, the personalized lighting system might achieve the same illuminance at the work surface 178 as from the ceiling-based lighting at height 160, but using only 22% as much power as the ceiling light source (of equal lumen/watt efficacy) at height 160. The illuminance may also be combined between the ceiling based lighting and the personalized lighting system, e.g., the illumination 166 from the personalized lighting system in this example case would be 40 foot-candles (fc) on the work surface 178, combined with an example illumination 162 of 40 fc from the ceiling mounted lighting to yield a combined 80 fc on the work surface 178. If the cubicle wall were at a medium height 168 of 53 inches from the floor 180, the personalized lighting system might be configured to 9% of the power output required by the ceiling light source to yield the same illumination 170 of 40 fc, which may or may not be combined with the 40 fc from the ceiling-mounted lighting. If the cubicle wall were at a low height 172 of 42 inches from the floor 180, the personalized lighting system might be configured to 3% of the power output required by the ceiling light source to yield the same illumination 170 of 40 fc, which may or may not be combined with the 40 fc from the ceiling mounted lighting. Again, these values are merely examples to illustrate how the personalized lighting system can be configured based on the environment, such as, but not limited to, lighting from other sources such as ceiling mounted lighting and the height of the mounting surface with respect to the work surface.

FIG. 6 shows how the personalized lighting system reduces energy consumption through closer proximity to the work surface from the hypotenuse perspective while at the same time increasing individual control over the lit environment. In FIG. 6, hypotenuse illumination control of a personalized lighting system is depicted in accordance with some embodiments of the invention, where both a personalized lighting system and ceiling mounted lighting are present. Based in part on the height 186 of ceiling mounted lighting, the illumination 188 from the ceiling mounted lighting can vary and may not be sufficient to light the work surface 78. The illumination level from a personalized lighting system mounted on a cubicle wall can be adjusted based on preference and/or the distance (or hypotenuse), etc. between the personalized lighting system and the work surface 204, in conjunction with or in the place of the illumination level from the ceiling mounted lighting, to provide the desired illumination of the work surface 204.

In one non-limiting, purely illustrative example, if the ceiling-mounted lighting is at a height 186 of 108 inches from the floor 206, with the work surface 204 at a height 202 of 29 inches from the floor 206, and the personalized lighting system is mounted on a high cubicle wall at a height 190 of 66 inches from the floor 206, the personalized lighting system might be configured to 29% of the power output required by the ceiling-based illumination to achieve the same illuminance at the work surface (assuming the both light sources have equal lumen/watt efficacies). The illumination from the light sources may also be combined; the illuminance 192 from the personalized lighting system in this example case would be 40 foot-candles (fc) on the target region of the work surface 204, combined with an example illumination 188 of 40 fc from the ceiling mounted lighting to yield a combined 80 fc on the work surface 204. If the cubicle wall were at a medium height 194 of 53 inches from the floor 206, the personalized lighting system might be configured to 17% of the power required by the ceiling-based light source to achieve the same illuminance at the work surface (assuming equal lumen/watt efficacies from both light sources) to yield the same illuminance 196 of 40 fc; this may also be combined with the 40 fc from the ceiling-mounted lighting. If the cubicle wall were at a low height 198 of 42 inches from the floor 206, the personalized lighting system might be configured to 11% of the power required by the ceiling-based light source to achieve the same illuminance at the work surface (assuming equal lumen/watt efficacies from both light sources) to yield the same illuminance 200 of 40 fc; this may also be combined with the 40 fc from the ceiling mounted lighting. Again, these values are merely examples to illustrate how the personalized lighting system can be configured based on the environment, such as, but not limited to, lighting from other sources such as ceiling mounted lighting and the height of the mounting surface with respect to the work surface. Various control algorithms can be used to control the personalized lighting system based on factors such as, but not limited to, vertical distance from the personalized lighting system to the region to be illuminated, angular or hypotenuse distance from the personalized lighting system to the region to be illuminated, other light sources and ambient lighting, input from general light sensors anywhere in the region, localized light sensing of the region of the work surface to be illuminated, etc. Single control schemes can be used, or multiple control schemes can be implemented and selected, or combinations of control schemes. For example, but not limited to, LEDs can be arrayed so that, for example, but not limited to, the LEDs can be individually or sub-group controlled in terms of light intensity/power so as to produce any desired, needed and/or required light distribution at the surface/location/etc. of a work space or other space. In some cases, one or more of the LEDs can be completely turned off to achieve the desired (etc.) pattern, distribution, uniformity, etc. For example, but not limited to, such an arrangement of light sources can be used to adjust for any undesired including personal preference or situational needs or requirements or other personal and/or professional needs, specifications, etc. for example, but not limited to, the hypotenuse distribution on a surface or projected on a surface, etc. It should also be noted that implementations of the light source(s) are not limited to any shape, form, function, size, etc. and can in general be of any type of shape, form or size including but not limited to any type of geometrical or other shape including but not limited to linear, square, circular, triangle, rectangular, donut, oblong, elliptical, triangles of any type and angular arrangement, any number of even and/or odd number of sides including but not limited to pentagon, hexagon, octagon, star, regular or irregular shapes, etc., combinations of these, etc. Based upon the disclosure provided herein, one of ordinary skill in the art will recognize a variety of light sources and configurations that can be included in the personalized lighting systems.

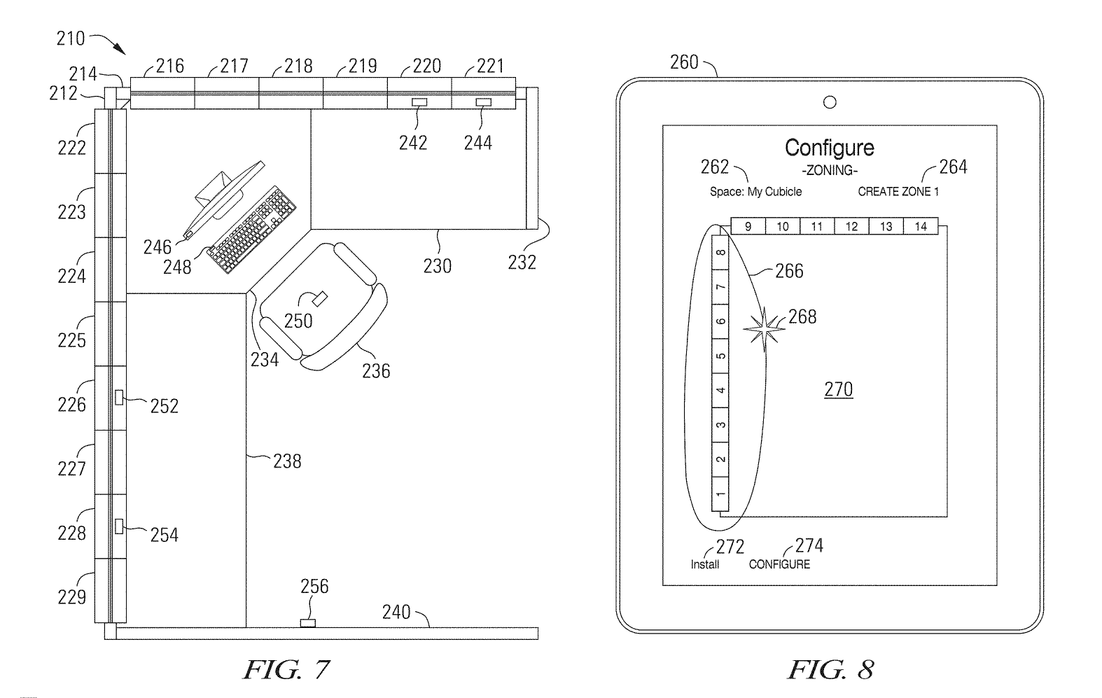

Turning to FIG. 7, a top view of a cubicle office space 210 is depicted with a personalized direct work surface lighting system in accordance with some embodiments of the invention. In this example, cubicle is formed by three full cubicle walls 212, 214, 240 and a partial cubicle wall 232 leaving a door or entry space, enclosing three desk surfaces 230, 234, 238 and chair 236. A personalized lighting system is installed on the top of cubicle walls 212, 214 to illuminate the desk surfaces 230, 234, 238, including light modules or strips 216, 217, 218, 219, 220, 221, 222, 223, 224, 225, 226, 227, 228, 229. The light modules 216-229 can be easily mounted to the cubicle walls 212, 214, for example with width-adjustable clamps, can be connected to one another, for example by sliding modules together so that power rails and control signal and/or data bus rails are connected between modules. The light modules 216-229 can be provided with reflectors and diffusers, etc., as depicted in various Figures herein, as well as variations thereof. Based upon the disclosure provided herein, one of ordinary skill in the art will recognize a variety of combinations of features from different embodiments disclosed herein that can be used in a personalized lighting system for both/either direct work surface illumination (which by definition herein can include reflectors), and/or indirect illumination such as, but not limited to, directing light toward the ceiling to provide ambient lighting. Again, vertical, tilted, manually, automatic or remote tilting or angular adjustment from the vertical or normal or horizontal, etc. can be included in embodiments and implementations of the present invention. Furthermore, the personalized lighting system can be configured to provide customized lighting to just one or to both sides of a cubicle wall or other barrier, for example lighting work spaces on both sides of a cubicle wall, lighting a work space on just one side of a cubicle wall without lighting the other side, or providing direct work surface illumination on one side of a cubicle wall and more general indirect lighting to the other side of the cubicle wall, such as to a corridor or aisle running along the other side of the cubicle wall, etc.

In some embodiments, motion and/or light or other sensors can be integrated in the personalized lighting system, for example including occupancy or vacancy sensors, such as but not limited to motion sensors of any type and form including but not limited to infrared, PIR, ultrasonic, microwave, proximity, sonar. RF, transducers and sensors, wearable and other device proximity, etc., combinations of these, etc., on one or more of the cubicle walls 212, 214, 232, 240, and/or on or under the desk 230, 234, 238, etc. If, for example but not limited to, no motion and/or occupancy has been detected in the cubicle for a predetermined period of time, for example, the personalized lighting system 210 can be dimmed or turned off, and turned on or up when, for example, but not limited to motion/occupancy is detected in the cubicle. Light sensors in the cubicle can be used to control dimming or power levels in the personalized lighting system to yield a desired lighting level on the desk 230, 234, 238. One or more occupancy/vacancy sensors (e.g., 244, 246, 248, 250, 252, 256) can be included in some embodiments of the system, connected to, for example but not limited to, light fixtures, cubicle structures, or elements within the cubicle, to computers/monitors/keyboards, to chairs, etc. One or more daylight harvesting sensors (e.g., 242, 254) can also be included in some embodiments of the system, connected to, for example but not limited to, light fixtures, cubicle structures, or elements within the cubicle, to computers/monitors/keyboards, to chairs, etc. Such sensor information can further be provided to users through a user interface, including but not limited to alerts or messages to the user via networked computer, text messages or other alerts on a smartphone or other portable device, etc. Implementations of the present invention can also control other devices, circuits, wall or other power, AC or DC power, power outlets, etc.

In some embodiments, the personalized lighting system can react to other detected conditions or emergency situations, such as providing lighting if a fire is detected, flashing if unauthorized entry is detected, etc., including but not limited to functions described in PCT patent application PCT/US16/56924 filed Oct. 13, 2016 for “Solid State Lighting and Sensor Systems”, which is incorporated herein by reference for all purposes.

Turning now to FIG. 8, an example user interface for configuration of a personalized lighting system is depicted in accordance with some embodiments of the invention. Such a user interface can be used for installing and provisioning a personalized lighting system, for example creating a group of solid-state lighting modules for grouped control, assigning a leader and follower modules, etc., and/or for controlling light levels, on/off state, color, color temperature, scheduled events, etc. in an existing personalized lighting system. The user interface can be provided on one or more of any suitable device, such as, but not limited to, an Internet connected computer, a smartphone or tablet 260 via an Internet and/or cellular connection, wired or wireless controllers mounted on a cubicle wall or as portable remote controls, through Bluetooth connections, 0 to 10 V, 0 to 2 V, 0 to 1 V, 0 to 3 V, etc., RS 232, RS485, DMX, DALI, WiFi, Bluetooth Low Energy (BLE or BTLE), ZigBee. Thread, 6LoWPAN, IEEE 801, IEEE 802, two wire, three wire. SPI, I2C, PLC, etc.

In one example depicted in FIG. 8, the user interface is displayed on a tablet 260, and is in a state providing for configuration of lighting zones, allowing for a zone or space to be named, and for light strips or modules in the space to be selected, grouped, and configured, for example by a finger press 268 to be dragged around a number of light modules to create a group 266 to be controlled together. In some embodiments, commands from the user interface are provided to a leader module in the group, which forwards the commands to follower modules in the group.

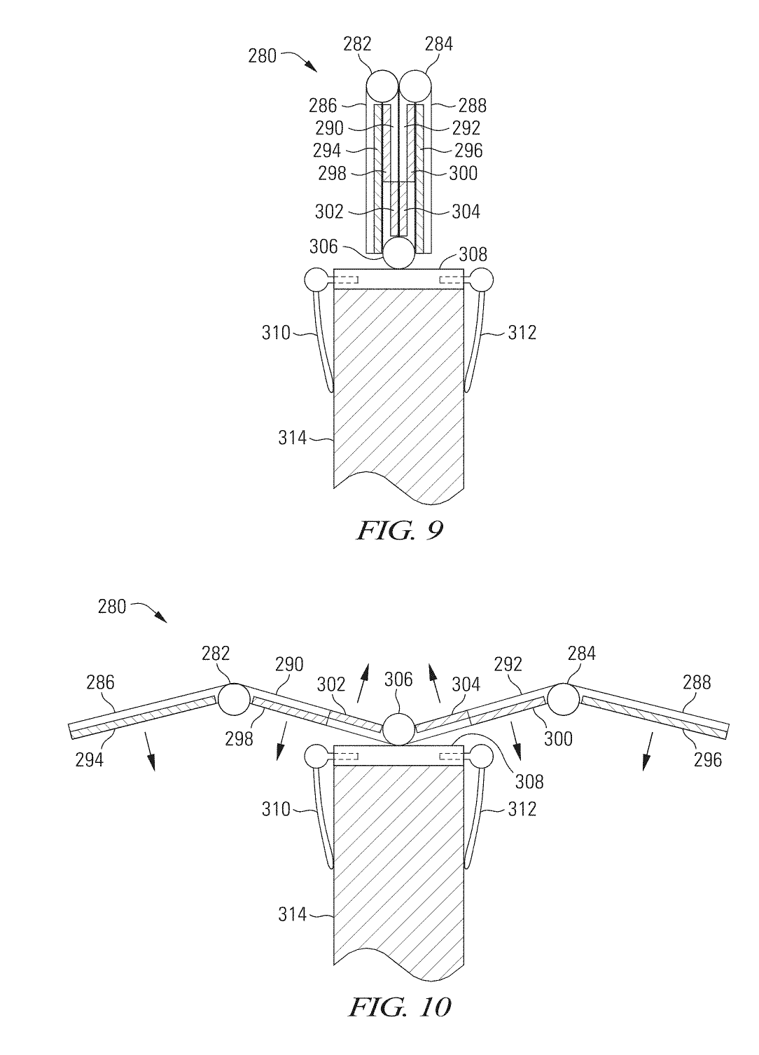

Turning now to FIGS. 9 and 10, another example embodiment of a personalized light system is depicted, in this case including folding panels 286, 290, 292, 288 which can be folded to conserve space and protect solid-state lights or other light source on the panels 286, 290, 292, 288, or extended to provide desired direct work space lighting and indirect lighting toward the ceiling, for example.

One or more solid-state lights or other light sources (e.g., OLED panels 294, 298, 302, 304, 300, 296), LED edge-lit panels, etc., are mounted on any number of panels 286, 290, 292, 288, which in some embodiments are mounted on pivots (e.g., 282, 306, 284), enabling the panels 286, 290, 292, 288 to be folded up. This can provide for orientation of the light panels 294, 298, 302, 304, 300, 296 to illuminate the desired directions or targets, can provide protection for light panels 294, 298, 302, 304, 300, 296 and can save space when in the folded configuration.

The personalized illumination system 280 can include a mounting assembly 308 with a fixed or variable-width clamping mechanism 310, 312 which can be used to mount the personalized illumination system 280 to a cubicle wall 314 or any other suitable mounting surface.

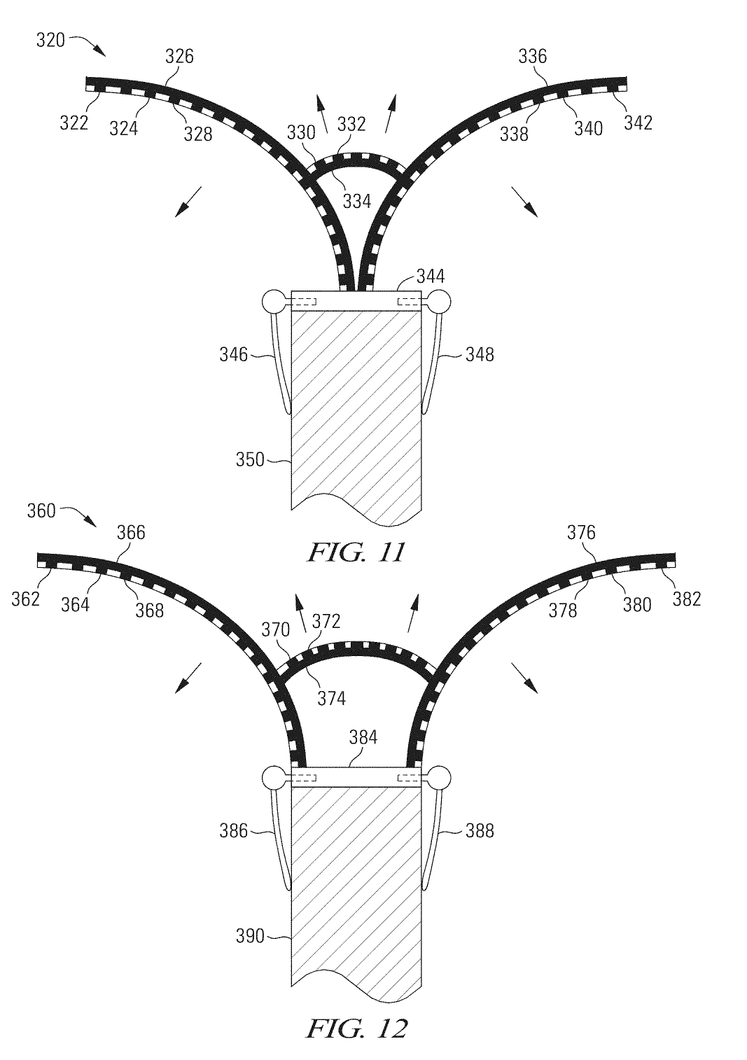

Turning to FIG. 11, a personalized illumination system 320 is depicted, which provides both direct work surface illumination and indirect ceiling illumination in accordance with some embodiments of the invention. In this embodiment, the personalized illumination system 320 includes curved bases 326, 334, 336 on which light sources (e.g., LEDs) 322, 324, 328, 330, 332, 338, 340, 342 are mounted, with optional diffusers covering the light sources 322, 324, 328, 330, 332, 338, 340, 342 to diffuse the light and provide protection. The personalized illumination system 320 can include a mounting assembly 344 with a fixed or variable-width clamping mechanism 346, 348 which can be used to mount the personalized illumination system 320 to a cubicle wall 350 or any other suitable mounting surface. In this embodiment, light can be directed down on one or both sides of the cubicle wall 350 to directly light work surface(s) as well as up toward a ceiling to provide indirect illumination of the area.

Turning to FIG. 12, another personalized illumination system 360 with a wider configuration is depicted, which provides both direct work surface illumination and indirect ceiling illumination in accordance with some embodiments of the invention. In this embodiment, the personalized illumination system 360 includes curved bases 366, 374, 376 on which light sources (e.g., LEDs) 362, 364, 368, 370, 372, 378, 380, 382 are mounted, with optional diffusers covering the light sources 362, 364, 368, 370, 372, 378, 380, 382 to diffuse the light and provide protection. The personalized illumination system 360 can include a mounting assembly 384 with a fixed or variable-width clamping mechanism 386, 388 which can be used to mount the personalized illumination system 360 to a cubicle wall 390 or any other suitable mounting surface. In this embodiment, light can be directed down on one or both sides of the cubicle wall 390 to directly light work surface(s) as well as up toward a ceiling to provide indirect illumination of the area.

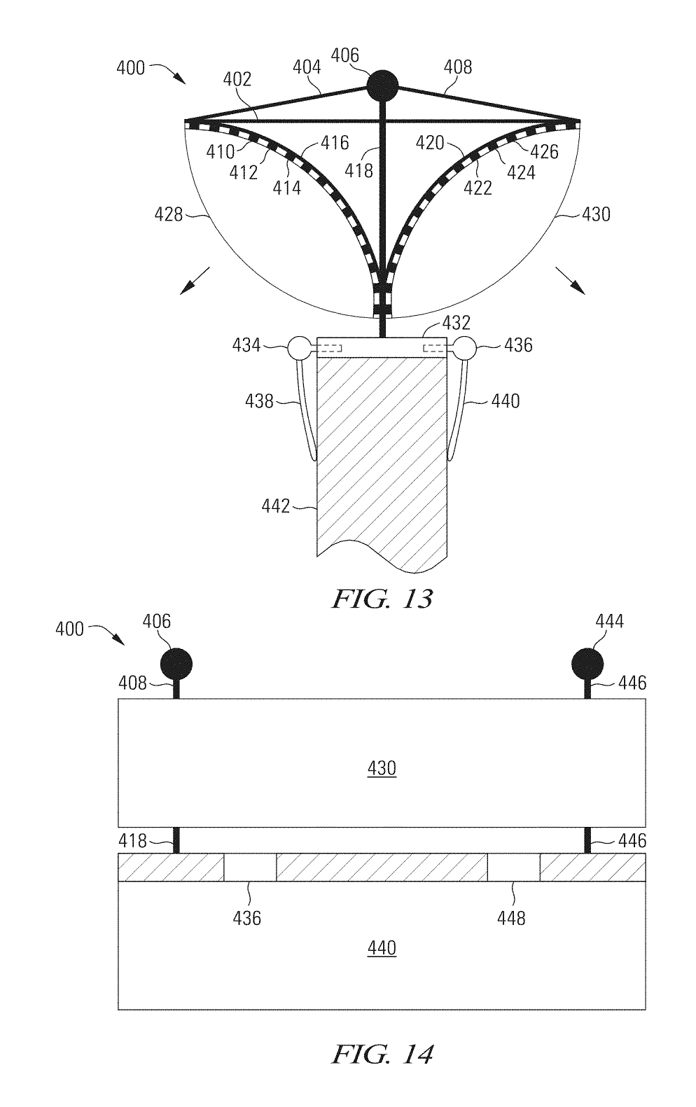

Turning to FIG. 13, a suspended personalized direct work surface illumination system 400 is depicted in accordance with some embodiments of the invention. In this embodiment, the personalized illumination system 400 includes curved bases 416, 420 on which light sources (e.g., LEDs) 410, 412, 414, 422, 424, 426 are mounted, with optional diffusers covering the light sources 410, 412, 414, 422, 424, 426 to diffuse the light and provide protection. The personalized illumination system 400 can include curved diffusers 428, 430 (or, in some cases, clear protective screens), which can be mounted on/suspended from support members (e.g., 418, 402, 404, 408, 406). The personalized illumination system 400 can include a mounting assembly 432 with a fixed or variable-width clamping mechanism 438, 440 (see clamp bodies 434, 436) or other mounting hardware which can be used to mount the personalized illumination system 400 to a cubicle wall 442 or any other suitable mounting surface. As shown in a side view in FIG. 14, support members (e.g., 418, 402, 404, 408, 406, 444, 446) and clamping mechanisms 434, 436, 434, 436, 448 can be included at any suitable locations on the personalized illumination system 400, such as, but not limited to, at ends of a lighting module or strip.

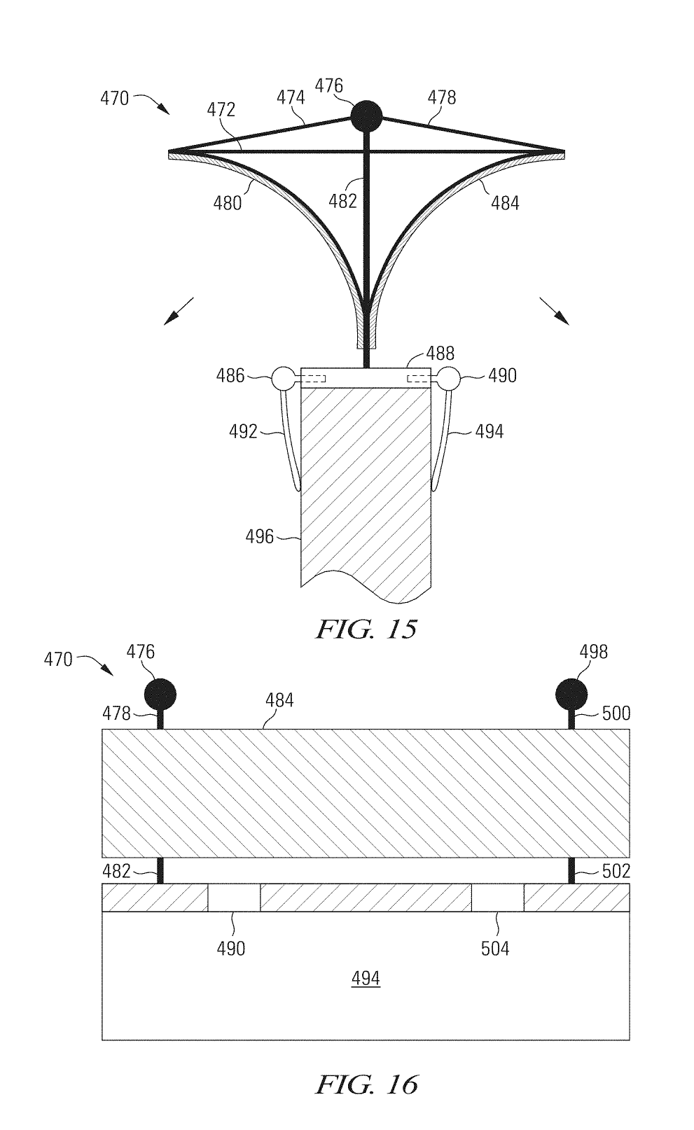

Turning to FIG. 15, a suspended curved panel-based personalized direct work surface illumination system 470 is depicted in accordance with some embodiments of the invention. In this embodiment, the personalized illumination system 470 includes curved bases on which curved light panels 480, 484 of any type are mounted. The personalized illumination system 470 can include a mounting assembly 488 with a fixed or variable-width clamping mechanism 492, 494 (see clamp bodies 486, 490) or other mounting hardware which can be used to mount the personalized illumination system 470 to a cubicle wall 496 or any other suitable mounting surface. As shown in a side view in FIG. 16, support members (e.g., 482, 472, 474, 478, 476, 500, 502) and clamping mechanisms 492, 494, 486, 490, 504 can be included at any suitable locations on the personalized illumination system 470, such as, but not limited to, at ends of a lighting module or strip.

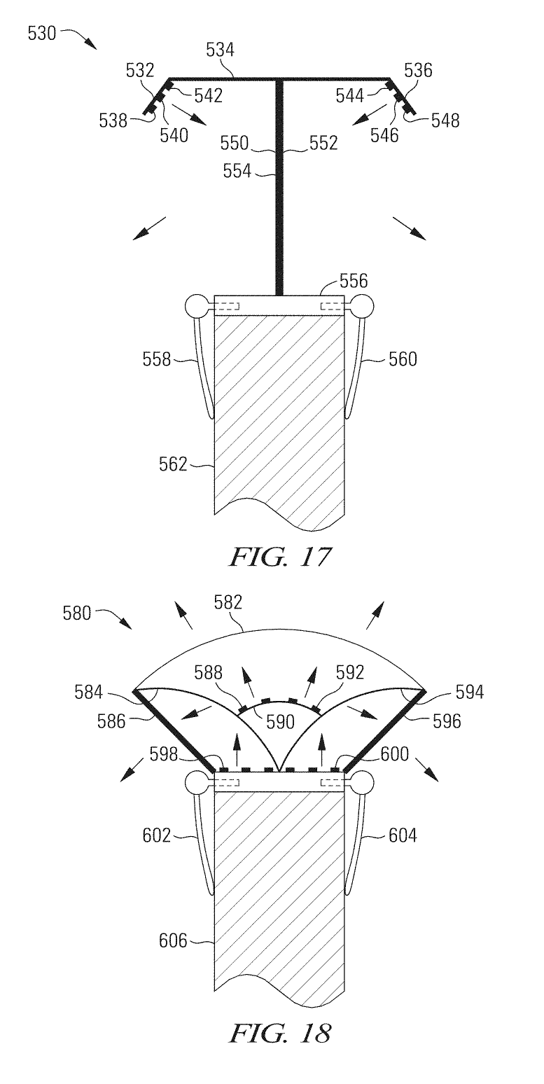

Turning to FIG. 17, a personalized direct reflected work surface illumination system 530 with two-sided reflector 554 is depicted in accordance with some embodiments of the invention. In this embodiment, one or more solid-state lights or other light sources (e.g., LEDs 538, 540, 542, 544, 546, 548), OLED panels. LED edge-lit panels, etc., are mounted on any number of panels (e.g., 532, 534, 536). In this embodiment, the panels (e.g., 532, 534, 536) are oriented so that the light sources (e.g., LEDs 538, 540, 542, 544, 546, 548) are directed somewhat downward, which can block them from direct view at least from standing occupants or passersby. Each side of the two-sided reflector 554 is provided with a reflective surface 550, 552 such as, but not limited to, a polished or otherwise reflective film made of any suitable material, a mirror, etc. The illumination from the light sources (e.g., LEDs 538, 540, 542, 544, 546, 548) is thus directed downward to directly illuminate work surfaces on both sides of a cubicle wall 562 or other mounting structure. In other embodiments, the personalized illumination system 530 is configured to illuminate only one side of the cubicle wall 562. The personalized illumination system 530 can include a mounting assembly 556 with a fixed or variable-width clamping mechanism 558, 560 or other mounting hardware which can be used to mount the personalized illumination system 530 to a cubicle wall 562 or any other suitable mounting surface.

Turning to FIG. 18, a personalized illumination system 580 is depicted that provides both direct work surface illumination and indirect ceiling illumination, including curved reflectors 584, 594 in accordance with some embodiments of the invention. In this embodiment, the personalized illumination system 580 includes one or more solid-state lights or other light sources (e.g., LEDs 598, 600), OLED panels, LED edge-lit panels, etc., mounted on a mounting assembly or main body of the personalized illumination system 580, in this case oriented upward toward curved reflectors 584, 594 which redirect and can be shaped to focus the illumination onto the target work surfaces. Optional diffusers 586, 596 can be provided to diffuse the light and to enclose the curved reflectors 584, 594. Additional solid-state lights or other light sources (e.g., LEDs 588, 592), OLED panels, LED edge-lit panels, etc., can be mounted to provide indirect illumination, for example on curved base 590, with optional curved diffuser panel 582, to direct illumination upward toward the ceiling to provide indirect illumination. The personalized illumination system 580 can include a mounting assembly with a fixed or variable-width clamping mechanism 602, 604 or other mounting hardware which can be used to mount the personalized illumination system 580 to a cubicle wall 606 or any other suitable mounting surface.

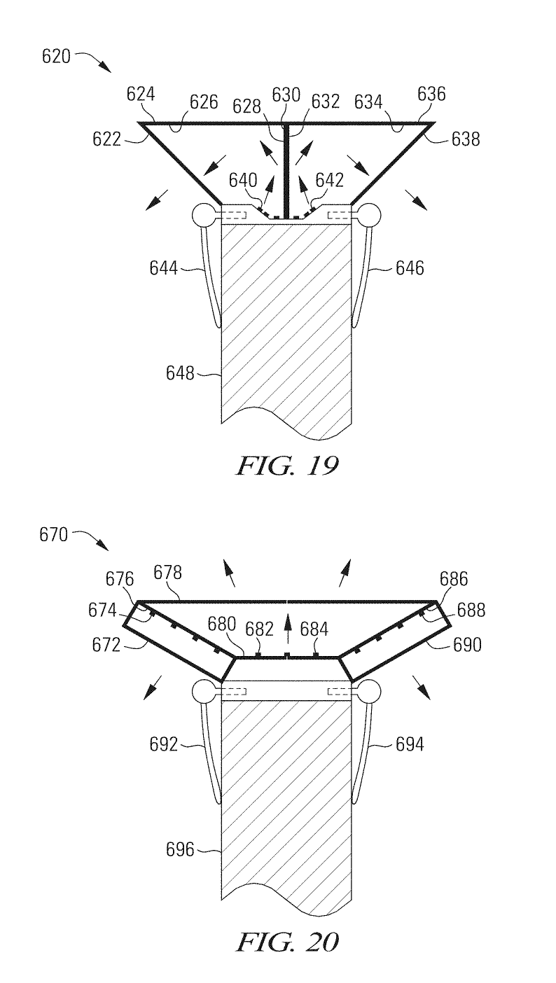

Turning to FIG. 19, a personalized direct work surface illumination system 620 with straight double reflectors 626, 628, 632, 634 is depicted in accordance with some embodiments of the invention. In this embodiment, the personalized illumination system 620 includes one or more solid-state lights or other light sources (e.g., LEDs 640, 642), OLED panels, LED edge-lit panels, etc., mounted on a mounting assembly or main body of the personalized illumination system 620, in this case oriented upward toward straight double reflectors 626, 628, 632, 634 which redirect illumination onto the target work surfaces. Optional diffusers 622, 638 can be provided to diffuse the light and to enclose the reflectors 626, 628, 632, 634. The reflectors 626, 628, 632, 634 and diffusers 622, 638 can be mounted using any suitable mounting assembly 620, 624, 636. The personalized illumination system 620 can include a mounting assembly with a fixed or variable-width clamping mechanism 644, 646 or other mounting hardware which can be used to mount the personalized illumination system 620 to a cubicle wall 648 or any other suitable mounting surface.

Turning to FIG. 20, a personalized illumination system 670 that provides both direct work surface illumination and indirect ceiling illumination with straight diffusers 672, 678, 690 is depicted in accordance with some embodiments of the invention. In this embodiment, the personalized illumination system 670 includes one or more solid-state lights or other light sources (e.g., LEDs 674, 682, 684, 688). OLED panels, LED edge-lit panels, etc., mounted on panels 676, 680, 686, oriented to provide direct work surface illumination on both sides of a cubicle wall 696 and to provide indirect ceiling illumination. The personalized illumination system 670 can include a mounting assembly with a fixed or variable-width clamping mechanism 692, 694 or other mounting hardware which can be used to mount the personalized illumination system 670 to a cubicle wall 696 or any other suitable mounting surface.

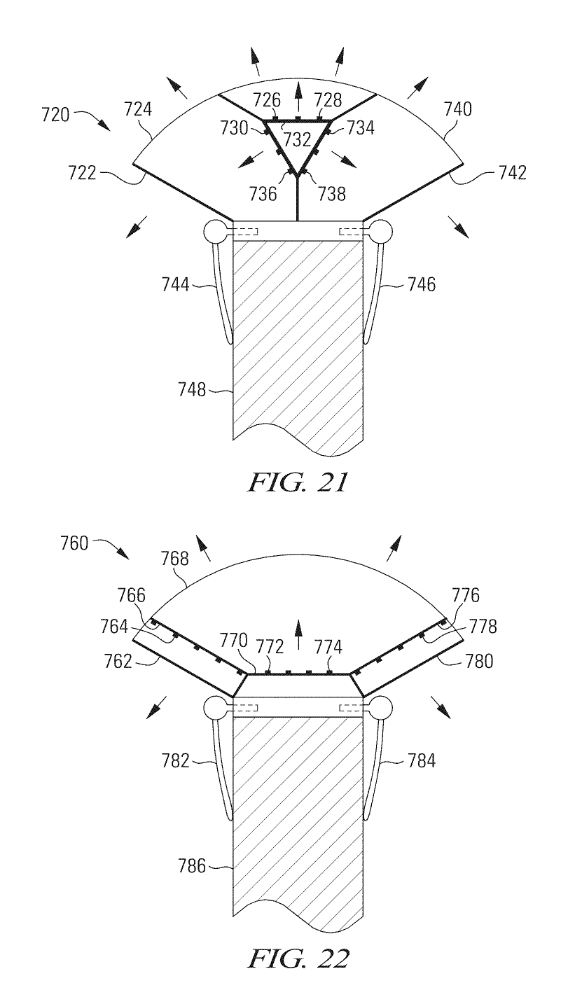

Turning to FIG. 21, a personalized direct work surface illumination system 720 is depicted with a multi-faceted base 732 with straight and curved diffusers 722, 742, 724, 740 in accordance with some embodiments of the invention. One or more solid-state lights or other light sources (e.g., LEDs 726, 728, 730, 734, 736, 738), OLED panels. LED edge-lit panels, etc., are mounted on different surfaces of the multi-faceted base/heat sink 732, for example with three facets, oriented to provide direct work surface illumination on both sides of a cubicle wall 748 and to provide indirect ceiling illumination. The personalized illumination system 720 can include a mounting assembly with a fixed or variable-width clamping mechanism 744, 746 or other mounting hardware which can be used to mount the personalized illumination system 720 to a cubicle wall 748 or any other suitable mounting surface.

Turning to FIG. 22, a personalized illumination system 760 that provides both direct work surface illumination and indirect ceiling illumination with straight and curved diffusers 762, 768, 780 is depicted in accordance with some embodiments of the invention. One or more solid-state lights or other light sources (e.g., LEDs 764, 766, 772, 774, 776, 778), OLED panels, LED edge-lit panels, etc., are mounted on panels (e.g., 770), oriented to provide direct work surface illumination on both sides of a cubicle wall 786 and to provide indirect ceiling illumination. The personalized illumination system 760 can include a mounting assembly with a fixed or variable-width clamping mechanism 782, 784 or other mounting hardware which can be used to mount the personalized illumination system 760 to a cubicle wall 786 or any other suitable mounting surface.

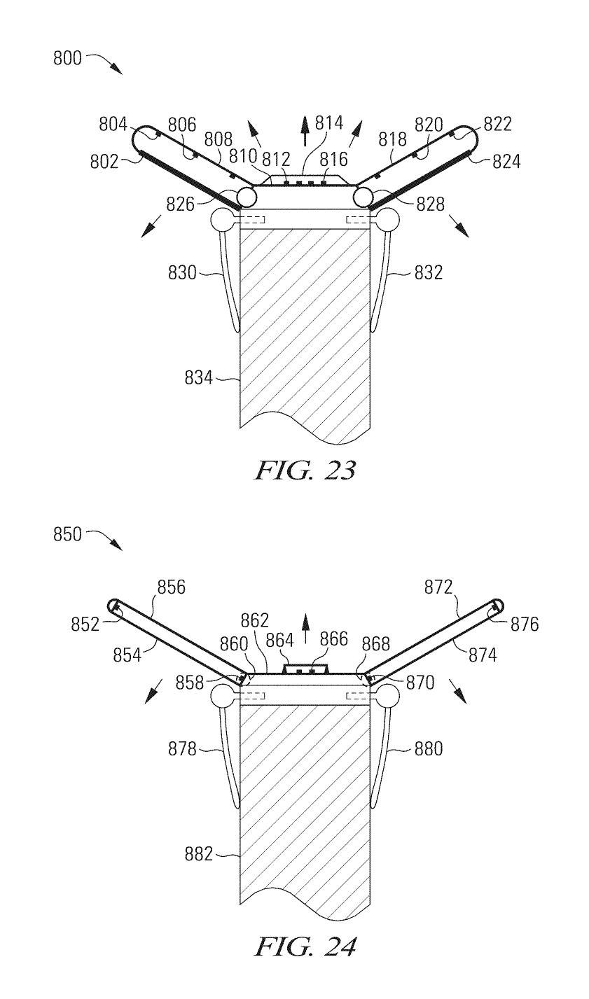

Turning to FIG. 23, a personalized illumination system 800 is depicted that provides both direct work surface illumination and indirect ceiling illumination with adjustable wings 808, 818 and diffuser (e.g., 802, 824 in some embodiments) with point light sources (e.g., 804, 806, 812, 816, 820, 822) and/or panel light sources (e.g., 802, 824 in some embodiments). The adjustable wings 808, 818 can be mounted on pivots 828, 828, allowing the adjustable wings 808, 818 to be angled at any desired angle to directly illuminate work surfaces, while light sources (e.g., 812, 816 with optional diffuser 814, mounted on surface 810 can be oriented upward toward the ceiling to provide indirect illumination. The personalized illumination system 800 can include a mounting assembly with a fixed or variable-width clamping mechanism 830, 832 or other mounting hardware which can be used to mount the personalized illumination system 800 to a cubicle wall 834 or any other suitable mounting surface.

Turning to FIG. 24, a thin edge-lit personalized illumination system 850 is depicted that provides both direct work surface illumination and indirect ceiling illumination with adjustable wings 856, 872 in accordance with some embodiments of the invention. The adjustable wings 856, 872 can be mounted on pivots 858, 868, allowing the adjustable wings 856, 872 to be angled at any desired angle to directly illuminate work surfaces, while light sources (e.g., 864, 866) with optional diffuser (not shown), mounted on surface 862 can be oriented upward toward the ceiling to provide indirect illumination. The panels 856, 872 can comprise edge-lit light panels, lit for example by point light sources 852, 858, 870, 876, or can comprise OLED or other lighting panels 854, 874, to directly illuminate work surface(s) below. In other embodiments, panels 856, 872 can comprise reflectors and panels 854, 874 can comprise diffusers. The personalized illumination system 850 can include a mounting assembly with a fixed or variable-width clamping mechanism 878, 880 or other mounting hardware which can be used to mount the personalized illumination system 850 to a cubicle wall 882 or any other suitable mounting surface.

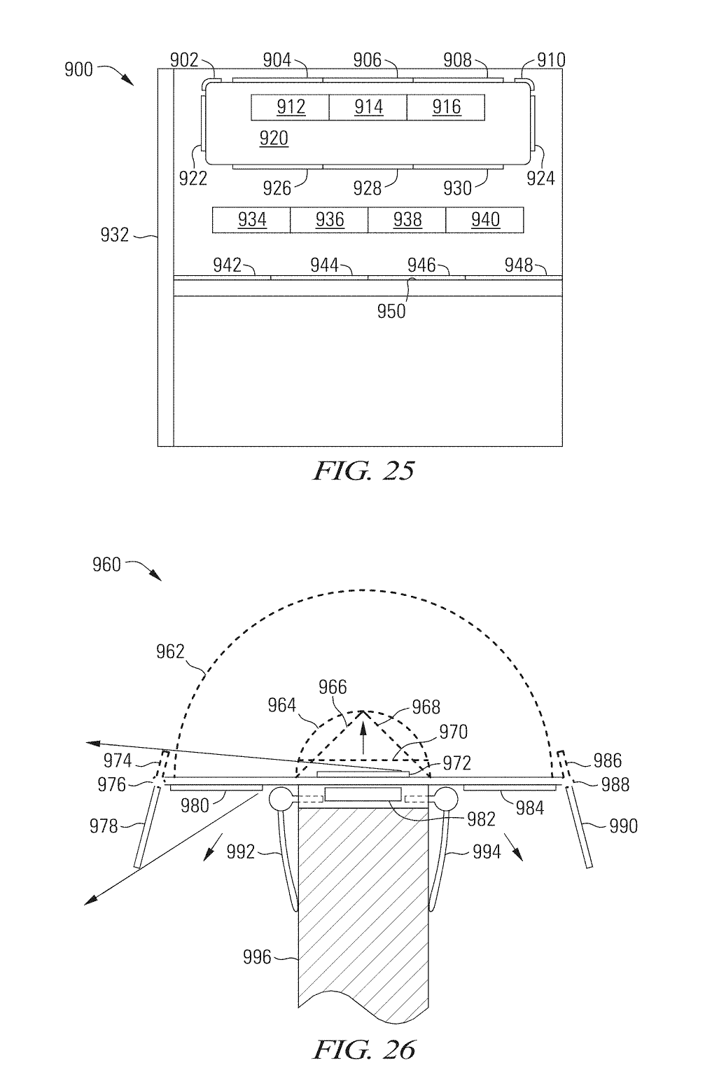

Turning to FIG. 25, a cubicle wall-mounted cabinet 920 with a personalized illumination system 900 is depicted in accordance with some embodiments of the invention. As described above, light sources/panels, sensors such as, but not limited to, occupancy/vacancy sensors, light sensors, daylight harvesters, etc., can be mounted in any suitable locations in a work or other space such as, but not limited to, a cubicle. For example, one or more of light panels 904, 906, 908, 912, 914, 916, 922, 924 926, 928, 930 can be mounted on a book shelf or cabinet 920 on a cubicle wall 932. Light sources can be directed to fiber optic, light pipe, edge-lit, side-lit, or other corner-mounted form factor light directors 902, 910 for single-direction or multi-direction illumination. Light sources/panels 934, 936, 938, 940 can be mounted directly to the cubicle wall 932 or in other various locations including, but not limited to, cubicle walls, cabinets, and wall additions to facilitate mounting, or light sources 942, 944, 946 can be mounted directly to the work surface 950, illuminating upward, downward, or in any desired direction, for example to provide a light table to illuminate up through work pieces such as negatives or films.

Turning to FIG. 26, a personalized illumination system 960 is depicted with optional glare deflectors 974, 976, 986, 990 and diffusers 962, 964, 966, 968, 970 in accordance with some embodiments of the invention. Optional glare shields or deflectors 974, 976, 986, 990 can be mounted on pivots 976, 988 or other slides or other mounts, enabling them to be oriented, moved, elongated or shortened, etc., to block direct illumination from light sources (e.g., 972, 980, 984) from the eyes of an occupant. Electronics controlling/powering/driving the light sources (e.g., 972, 980, 984) can be provided in any suitable location, such as in an electronics housing 982 in the personalized illumination system 960. The personalized illumination system 960 can include a mounting assembly with a fixed or variable-width clamping mechanism 992, 994 or other mounting hardware which can be used to mount the personalized illumination system 960 to a cubicle wall 996 or any other suitable mounting surface.

Light sources in the personalized lighting systems can be positioned and/or oriented to reduce distance to work surfaces, thereby saving power, increasing efficiency and individualized control.

In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics.

Some embodiments of the present invention may use multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by, for example, but not limited to, SSL including but not limited to LED, OLED and/or QD lighting.

The solid state lighting systems can include single and multi-color lights including RGB. White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc.

Color-changing/tuning can include, but is not limited to, white color-tuning including the color temperature tuning/adjustments/settings/etc., color correction temperature (CCT), color rendering index (CRI), etc. including but not limited to with one or more of a red, green, blue, amber, cool white (i.e., relatively high kelvin color temperature), warm white (i.e., relatively low Kelvin color temperature), etc., combinations of these, etc., combinations that produce full spectrum lighting, etc.

Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. Some embodiments of the present invention can change to different colors when using light sources capable of supporting such (i.e., LEDs, OLEDs and/or QDs including but not limited to red, green, blue, amber, white LEDs and/or any other possible combination of LEDs and colors).

Embodiments of the present invention have the ability to store color choices, selections, etc. and retrieve, restore, display, update, etc. these color choices and selections when using non-fluorescent light sources that can support color changing and can also coordinate, copy, duplicate color setting including but not limited to color settings that are stored, coded, interpreted, etc. in digital format.

The power supply/supplies and/or driver(s) can be any suitable circuit based on the requirements of the solid state lighting and the voltage and/or current output, such as, but not limited to, a dimmable constant current driver. The solid state lighting can be any type of solid state lighting including but not limited to light emitting diodes (LEDs), organic light emitting diodes (OLEDs), quantum dot-based (QD)-based LEDs, etc. The solid state lighting can comprise a digital lighting platform as well as a sensor, detector, communications, etc. power hub, source and support for digital communications of all types and forms including but not limited to big data, environmental, information, entertainment, infotainment, etc.

Power can be converted by power supply/power supplies to power loads which can be, but are not limited to, internal circuits in the solid state lighting system, sensors, internet of things (IOT), sensors, detectors, devices, etc. including but not limited to those discussed herein such as motion, sound, light, temperature, etc., sensors, detectors, controllers, as well as communications devices including but not limited to wireless, wired, powerline, combinations of these, etc.

Switches can be implemented in any suitable manner, using internal or external switches or a combination of these, mechanical, electromechanical, solid state, relay, etc., of any types and forms, etc., combinations, etc., semiconductor such as, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

In some embodiments, the power supply or supplies can be used to generate power for internal circuits, sensors, etc. as well as external circuits, sensors, IOT, controls, communications, detectors, sirens, cameras, arrays, pattern, voice, sound, facial, etc. sensors, detectors, etc., combinations of these including but not limited to those discussed herein without impacting the constant current to the lighting output(s). In some embodiments of the present invention, the light output may be directly controlled or regulated with one or more isolated or non-isolated outputs may be used to provide internal and/or external power to sensors, IOT, controls, communications, etc., combinations of these, etc.

Some embodiments of the invention include Identification Switches with, for example but not limited to, RFID and/or NFC. Various embodiments can have mechanical to electrical switching and/or gesture detection, etc., for example, but not limited to ZigBee to RFID, BTLE to RFID, etc. Control circuits can interface powered by any source, including but not limited to, power from the AC line, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet. DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc. WiFi to RFID, vice-versa, etc., two-way communications, etc. Embodiments of the present invention can also be powered by low voltage output power sources (e.g., 2208, 2218) including with power over Ethernet (POE). Power switching and/or dimming can be of any known type including but not limited to electromechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

Some embodiments of the invention include circuits to link to watches and in particular smart watches, wearable watches, health monitoring watches, FitBit, Apple, Nike, Android based smart watches and wearables, etc.

Some embodiments of the invention include circuits to link to watches and/or other types of wearables to interact with, control, dim, monitor, light and other systems.

Some embodiments of the invention include motion detectors for outdoor outside that can have motion sensor, ultrasonics, noise, etc. separate from the light source and connected via Bluetooth Smart, BLE, USB, use WEB and other info including but not limited to weather, wind, wind speed, could coordinate with other sensors, lights, etc., feedback information, etc.

Some embodiments of the invention includes lamps that can be all or partially screen printed, 3D printed, etc. including custom designs, customized designs, etc. using, for example, UL or CE approved, recognized, listed, etc. materials.

Some embodiments of the invention use proximity sensors and/or beacons, identifiers, etc. to identify who is near including by cellular/smart phone, smart watch, other Bluetooth devices, RFID, others, etc. and take appropriate actions including settings selection based on profile information stored, learned, taught, trained, memorized, etc., combinations of these, etc.

Some embodiments of the invention advertise and obtain Bluetooth and other ID, etc.

Some embodiments of the invention use display panels including but not limited to OLED panels, tablets, etc. as lighting panels.

Some embodiments of the invention use a synchronous bridge for the dimmer. Some embodiments of the invention can also have a TRIAC that is, for example, but not limited to being in parallel with the diodes and transistors of embodiments of the present invention.

Some embodiments of the invention include motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Implementations of the present invention can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors.

Some embodiments of the invention include sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging.

Some embodiments of the invention are adapted for use in stairwells, etc. especially ones that have doors to entry, use a device that makes a sound when the door is opened so that the light source ‘hears’ the sound and turns on. Implementations of the present invention can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments of the invention can use active or passive or both high pass, low pass, bandpass, notch, other filters, combinations, etc. including with the voice, sound, noise detection.

Some embodiments of the invention can use isolated digital PWM that can be converted to analog near the control reference point.

Some embodiments of the invention can use proximity and/or signal strength to decide, for example, but not limited to turn on or off lights, etc.

Some embodiments of the invention can flash at the end of an allotted time to indicate that the next group is ready to use, for example, a conference room.

Some embodiments of the invention can listen for and respond to emergency sounds such as smoke, fire, carbon monoxide (CO), carbon dioxide (for, for example but not limited to, both health and occupancy information), etc. detectors, sensors, etc. by flashing, turning on, forwarding the information, alert, alarm, etc.

Some embodiments of the invention can be powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422. RS423. SPI, I2C, UART, Ethernet, ZigBee, Zwave. Bluetooth, BTLE, WiFi, cellular, mobile, ISM, Wink, powerline, etc., combinations of these, etc.

A wired and/or wireless controller/dimmer/monitor can be used for use in a solid state lighting system in accordance with some embodiments of the invention. Solid state lights of any color or of variable color, or of any color temperature or combinations of such, such as, but not limited to, red, green, blue, amber, white, etc. and of any type can be provided. In some embodiments, an on/off switch is provided. In some embodiments, a button/switch/etc. is provided for turning on/off one or more parts of the present invention. In some embodiments, a control interface is provided, which can be wired (i.e., analog and/or digital, serial, parallel, UART, SPI, I2C, RS232, RS485, RS422, other RS/EIA, etc. standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.) or wireless (Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these, etc.) In some embodiments, a powerline interface is included to control lights or other devices. In some embodiments, an encoder or potentiometer is included for manual control. In some embodiments, a button/switch is included for enabling/disabling/controlling dimming of parts or all of the present invention. Again, such a wired and/or wireless controller/dimmer/monitor is a non-limiting example of a control interface for a solid state lighting system.

A solid state lighting system can be color controllable multiple light sources in accordance with some embodiments of the invention. For example, a solid state lighting system may include a solid state light with multiple flat lighting panels (e.g., OLED panels or edge-lit panels) and multiple solid state point light sources, such as LEDs. The shape, layout, form factor, and types and numbers of light sources are merely examples and should not be viewed as limiting in any manner. Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc. In some embodiments, the SSL can provide evening/night light using for example amber-orange-yellow SSLs including but not limited to LEDs and/or OLEDs that can be dimmed, flashed, color-changing, sound alarms, sequence, provide time of day and circadian rhythm and/or other health therapy or ailment alignment, information, etc. Some embodiments of the present invention can have light, motion, proximity, noise, sound RFID, NFC, etc. sensors that are either internal or external and connected by one or more of wired, wireless, powerline communications (PLC), etc.

Some embodiments of the present invention can include LEDs. OLEDs. QDs, other SSLs, other types of lights, etc. combinations of these, etc. and can include combinations of flashing, sequencing, dimming, changing colors, individually and/or collectively, etc., sirens, alarms, alerts, web connectivity, wired, wireless and/or PLC, etc.

Example embodiments of solid state lighting systems with isolated control inputs can be used in accordance with some embodiments of the invention. The SSL systems can be powered by any suitable source(s). Power supply circuits can pass power through to solid state lights and can provide one or more of the functions disclosed herein, such as, but not limited to, current control, undervoltage protection (UVP), overvoltage protection (OVP), short circuit protection (SCP), over-temperature protection (OTP), etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

Various embodiments of the present invention are backward (and forward) compatible and can be completely interoperable with existing energy management systems and can be used with different brands of equipment already installed. Embodiments of the present invention can also support demand response requests including load shedding by reducing the power to the respective lighting and other facilities, accessories, power consumers, etc. including the HVAC and also determining which areas, cubicles, are occupied or unoccupied. In addition, embodiments of the present invention can determine the power consumption of the lighting and other electrical usage such as AC wall outlets, computers, personal and/or localized heaters, fans, air conditioners, etc. and combine and aggregate power usage by individuals, sub-groups, areas, locations, functions, floors, zones, sub-floors, buildings, campus, campuses, etc. Implementations of the present invention can receive, interpret, utilize, etc. signals generated for example but not limited electric utility companies, local, regional, national, etc. energy/power providers, etc. Such signal(s) can be used to not only turn off or dim/trim down the lighting of individual cubicles, groups of cubicles, and/or spaces, etc., combinations of these, etc. it can also turn down or, if necessary, off non-critical electrical operations and also decrease/turn down HVAC including but not limited to air conditioning while monitoring individual and group cubicles including the temperature, air quality, general environment. etc. of these cubicles. The present invention also allows for one, two, effectively any number of employees or inhabitants of cubicles to move to other similar cubicles and have their respective lighting profiles and preferences be transferred to that cubicle including by but not limited to electronically transferring the profile and preference information via connected computers and devices including but not limited via the cloud, the edge, the Ethernet, the Internet, servers, data centers, mobile/cellular phone carriers, etc., combinations of these, etc.

Some embodiments include one or more dimmers that can remotely set the minimum and maximum dimming levels, set local control, both remote and local control or local lockout, track the manual settings and changes, control, dim and monitor using one or more, for example, but not limited to phase cut dimming (forward, reverse and/or both, etc.), wired dimming including analog (i.e., 0 to 3 V, 0 to 10 V), digital (i.e., DALI, DMX. SPI, I2C, WiFi, BTLE, etc., combinations of these, etc.) and/or combinations of these, etc., wireless including, for example, but not limited to, RF and/or Optical/IR, etc. (i.e., ZigBee, LiFi, WiFi, Bluetooth, BTLE, etc., combinations of these, etc.), PLC, etc., combinations of these, etc. Embodiments of the present invention can monitor the power consumption/energy usage including by direct AC or DC line power, power to and through the lamps that are powered by other types of energy and power sources that can, for example, wired or wirelessly provide power, current, voltage, power factor, usage, energy consumed (i.e., kWH, etc.), etc. Such implementations of the present invention can also incorporate and use internal and/or external sensors including but not limited to light, motion, proximity, sonar, ultrasonic, sound, voice, mechanical, daylight harvesting, combinations of these, etc.

Again, embodiments and implementations of the present invention can use one or both (e.g., combinations) of analog and/or digital dimming including hybrids or switching between, back and forth, from one to the other. etc. of analog and digital dimming and control. Embodiments of the present invention including the cubicle/personal space lighting and the other lighting such as ceiling, task, wall, desk lamp, emergency, etc., combinations of these, etc. can all be dimmed/controlled in the same or similar manner as well as all can be monitored for input and output power, current, voltage, power factor, harmonics, total harmonic distortion, etc.

Some embodiments of the dimmer control can use forward and/or reverse phase cut dimming, voltage and/or current dimming/reduction/etc.

Some embodiments of the present invention include a dimmer that allows for one or more buttons or other similar methods including but not limited to buttons, indents, etc. that allow other types of lighting such as but not limited to dimmable or on/off that are powered by other things including fans, heaters, furnaces, air conditions, humidifiers, etc. Such buttons, controls, etc. can also utilize light indicators including LED, OLED, QDs. etc. to show what is being controlled, acted on, etc.

As an example solid state lighting system with a dimmer implementing control and monitoring, communications with other devices, settings for lighting, sensors, etc., limits such as, but not limited to, dimming limits, storage, logging, tracking, lockout adjustment(s), etc. The dimmer can receive control signals, whether wired or wireless, from sources or systems such as, but not limited to, phase cut dimmers (forward and/or reverse), wired analog and/or digital controllers/monitors, any wireless sources, powerline communications (PLC) networks, etc. The solid state lighting system can also include one or more of any or all of light sensors, motion sensors, sound sensors, ultrasonic sensors, or other sensors. The system can include one or more light sources with wired and/or wireless control/dimming and/or monitoring, one or more AC phase controlled light(s) with control/dimming and/or monitoring, and one or more AC powered light(s) with wired and/or wireless and/or PLC control/dimming and/or monitoring as well as other lighting sources of any type or form including florescent lighting, solid state florescent lighting replacements (FLRs), incandescent, high intensity discharge, etc., outdoor lighting that can also optionally interact with the present invention.

The dimmer can also have dedicated remote control in addition to smart phone, tablet, computer, server. etc. control. Such a dimmer can have one or more additional switches and associated controls to provide on/off of input to ballasts etc. either locally or remotely. For example, but not limited to, a graphics user interface (GUI) can be installed on one or more desktop or laptop computers, or servers, etc. that permits, for example, but not limited to, dimming, trimming, color-changing, color temperature tuning, etc., combinations of these, etc. as well as optional monitoring, storing, data tracking, storage, mining, etc.

Embodiments of the present invention can use the solid state lighting power supply to power circuits in the solid state lighting power supply or any other desired load including but not limited to sensors. IOT, controls, communications, etc. including but not limited to those discussed herein, combinations of these, etc.

Voltage regulator(s) can be a linear regulator or can comprise a buck converter circuit or, in other embodiments, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc.

In some embodiments, an over-current protection circuit dither circuit, under-voltage protection, or any other control and protection signals and circuits can be used with the PWM control or other type of pulse control, including but not limited to over-temperature protection, over-voltage protection, etc.

One or more windings can be used to provide power to, for example, but not limited to, microcontroller(s) (etc.), communications radios (e.g., WiFi. ZigBee, Bluetooth, etc.) lights, sensors, detectors, IOT, controls, etc. The voltage feedback signal can be isolated or level shifted, for example by opto-isolator(s) to provide feedback to the PWM control circuit, enabling it to control the duty cycle on switch(es), thereby regulating voltage(s).

The solid state lighting dimmer can include an AC zero crossing circuit comprising voltage regulator and capacitors, resistors, AC opto-isolators, etc. The AC opto-isolator can be driven, for example by the AC input signal, so that the AC opto-isolator is turned off at zero crossings and otherwise is on.

The solid state lighting dimmer can also include a dimmer switch with back to back transistors driven by a PWM output signal to yield a dimming signal.

In some embodiments, the AC powered lighting, the FLRs, the POE, and/or other sources of powered lighting can have sensors in the solid state lighting system that have auxiliary ports that allow both control signals and other types of sensors, detectors, features, functions, etc. including, for example, but not limited to, motion, sound, video, vision recognition, pattern recognition, etc., combinations of these, etc. The indoor and outdoor embodiments can be very similar except for being weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well-being watches, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc. Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as an intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc. Embodiments of the present invention can also use daylight harvesting, light sensing etc.

Some embodiments of the solid state lighting system can be configured, controlled, monitored, etc., from/to smart devices using for example, but not limited to, Apps, laptops, desktops, servers, mobile and/or PDA devices of any type or form, combinations of these, etc.

Some embodiments include motion sensors performing multiple duties, such as, but not limited to, turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments include motion sensors that can track, log, measure, determine, predict, guess, etc., the motion, the path, the direction, the way a person or persons or traffic, etc. will take, etc., can communicate including but not limited to wired, wirelessly, PLC, etc. to other units, people, computers, controllers, monitors, storage devices, human services, animal services, public services, police, fire, first responders, security personnel, family members, friends, guardians, etc.

Some embodiments include controllers with smart additional components, accessories, etc. Such controllers can use weather information, including from any source such as a local weather station, personal weather station, web-based weather report, etc. In some cases, weather is monitored locally, regionally, wind factor, have a wind indicator, etc., wind vane, wind generator, etc. Such controllers can also dim, flash, change intensities, white colors, be color-changing, etc., communicate two or more way, etc.

Some embodiments can use barcodes or scancodes, etc. for digital devices to read including app based codes that can be scan and read, for example, but not limited to, by a cell phone or a tablet, for example when provisioning a system with multiple FLRs.

All of the above can be seamlessly connected together and share, enjoy, use connectivity to communicate to one another. Any and all of the above can have two way communications including providing information on use, power use, current and voltage use, dimming, health, lighting health, sensor(s) settings and health, and readings, etc., power factor, efficiency, energy harvesting, harmonic distortion, total harmonic distortion, temperature, humidity, light, ambient conditions including both indoors and outdoors, other electrical, optical, mechanical, weather, etc. conditions, information, etc. Any and all of the embodiments of the present invention can be made weather-proof.

Some embodiments of the present invention can be used to treat, support, enhance. etc. health, to aid in treatment and recovery of ill, sick, injured individuals and groups including individuals and groups recovering or experiencing various physical and mental diseases and health issues.

Embodiments of the present invention are designed to be a cost-effective and complete solution that provides both forward and backward compatibility which is also ideal for retrofits and can use either wireless or wire (or both) communications.

Some embodiments of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, WiFi, sub-gigahertz, proprietary radio, other radio frequencies, other frequencies in the electromagnetic spectrum, other protocols, standards, interfaces, etc., combinations of these, etc.

Some embodiments of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Some embodiments of the present invention support and can include color changing, color tuning, etc. lights with numerous ways to interact with the lights.

Some embodiments of the present invention can be integrated with video, burglar, fire alarm, etc. components, systems.

Other features and functions include but are not limited to detecting the frequency using a microprocessor, microcontroller. FPGA. DSP, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level.

Some embodiments of the present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

Some embodiments of the present invention provide two or more side (multi-side) lighting for example but not limited to, for the cubicle and/or for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc.

The present invention can work with all types of communications devices including portable communications devices worn by individuals, walkie-talkie types of devices, etc.

The present invention can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

Some embodiments include one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, sub-gigahertz, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces, protocols, device, circuits, systems, etc. In some embodiments the thermometer(s) and/or thermostat(s) can communicate with each other and relay, share, augment, modify, interpret, add to, subtract from, and pass commands as well as provide information and data to one another.

In addition, some embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802. ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

Some embodiments support various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

Some embodiments include a global positioning system (GPS) to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Some embodiments of the present invention use/incorporate/include/etc. thermal imagers including but not limited to IR imagers, IR imaging arrays, non-contact temperature measurements including point temperature and array temperature measurements including in lighting such as the cubicle lighting of the present invention and T8, T12, T5, etc. FL replacements where the imagers are powered by, for example, but not limited to the ballast for the FLR and the AC line via a converter for AC line powered lighting.

Some embodiments allow for dimming with both ballasts of any type including but not limited to electronic and magnetic ballasts and AC line voltage.

Some embodiments can be used, for example, but not limited to, for daylight harvesting/vacancy and/or occupancy uses and applications.

Some embodiments use wireless signals to both control (i.e., dim) the cubicle lighting and/or LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent SSL/LED FLRs and the cubicle lighting are compatible with most daylight harvesting controls and protocols. Optional sensors allow for relative light output to be measured and wirelessly reported, monitored, and logged permitting analytics to be performed. Embodiments of the present invention come in a diversity of lengths including but are not limited to two foot and four foot T8 standard/nominal linear lengths as well as T12 as well as any other type of fluorescent and/or HID lamp including but not limited to those discussed herein. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or ZigBee, ZWave, IEEE 802, or WiFi or Bluetooth or any type of form. In addition to occupancy/vacancy/motion sensors, photo sensors and daylight harvesting controls, simple and low cost interfaces that allow existing other brands, makes, and models of daylight harvesting controls, photo sensors, occupancy/vacancy/motion sensors to be connected to and control/dim embodiments of the wireless SSL/LED FLRs. The cubicle lighting and/or SSL FLR can be switched on and off millions of times without damage as well as be dimmed up and down without damage. The wireless communications can be encrypted and secure. Such embodiments of the present invention FLRs do not require or need a dimmable ballast and work with standard ballasts.

Some embodiments have integrated motion sensor(s) as part of the housing and can also use auxiliary motion sensors and can also have integrated light/photocell sensor as well as auxiliary. Such embodiments of the present invention can have the sensors discussed herein incorporated into the housing body or can have a cable or wireless connection to the sensors including having the one or more sensors mounted on the outside of the fixture, near the fixture or further away and more remote, etc. combinations of these, etc.

Some embodiments respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, any other type of sensor, detector, identifier, analog and/or digital ID, combinations of these including but not limited to those discussed herein, etc. In addition the present invention can be connected to fire alarms, fire alarm monitoring equipment, burglar and security protection company and services, health services, etc.

Some embodiments permit enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form. DVD and other entertainment lighting and displays containing LEDs, OLEDs, CCFLs, FLs, CRTs, etc., displays, monitors, TVs, OLED. LED, CCFL, FL, incandescent lighting, etc.

Some embodiments use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters.

Some embodiments use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

Some embodiments use TVs essentially of any type or form, including, but not limited to smart TVs. and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

Some embodiments respond to proximity sensors including passive or active or both, as well as voice commands and can be used to turn on, turn off, dim, flash or change colors including doing so in response to an emergency situation. The present invention can use wireless. wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, home and/or business monitoring, protection services and companies, etc.

Some embodiments use a BACNET to wireless converter box or BACNET to a wired or wireless device including but not limited to Bluetooth including Bluetooth low energy (BLE), WiFi, Zigbee, Thread, 6LowPAN, DALI, DMX, 0 to 10 V, etc., combinations of these, etc. The present invention can also use infrared signals to control and dim the lighting and other systems as well as other types of devices including but not limited to heating and cooling, thermostats, on/off switches, other types of switches, etc.

Some embodiments include a motion proximity sensor that sends signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to field installable add-ons and/or upgrades including but not limited to hardware, firmware, software, etc., combinations of these, etc. including but not limited to wired, wireless or powerline control to be added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelength and/or wavelengths of light at appropriate times.

Some embodiments include internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

Some embodiments include some or all of sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors. RF sensors, proximity sensors, sonar sensors, radar sensors, etc., cameras of any type and form including but not limited to one or more and more than one each of security cameras, infrared cameras, web cam (cameras), closed circuit cameras, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be either active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field.

Embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors. SSL including but not limited to the LED. OLED, and/or QD lighting may use phosphor converted (PC) technologies, techniques, etc. and may be QC-based products, etc. In addition, microLEDs and related devices, technologies, techniques, approaches, etc. including PC-microLEDs may be used with and incorporated into embodiments and implementations of the present invention, etc.

Some embodiments and implementations of the present invention can set user requirements, password priorities, permission levels, etc. for all or parts of the system including down to the individual lamp/bulb level which can/may be controlled, managed at a central or distributed level and can use mesh techniques to propagate information, commands, passwords, authentications, etc.

Some embodiments include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, MR16, track lighting, low voltage lighting including but not limited to legacy incandescent and halogen lighting as well as SSL/LED replacement lighting, dimmable compact florescent lamps, incandescent bulbs, halogen bulbs, etc. as well as smart dimmable (i.e., by wired, wireless, powerline communications, etc., combinations of these, etc.), infrared controlled devices including lighting of any type and form including dimmable and/or color-changing, color temperature (CCT) changeable/tunable lighting of any type and form, etc., heaters of any type or form, air conditioners of any type or form, color-changing, color-tunable, white color-changing, lighting of any type including but not limited to those discussed herein. Non-dimmable lamps and appliances and entertainment device can also be included in such implementations of the present invention and may be turned on and off by one or more of the smart on/off switches or a dimmer that is, for example, but not limited to, programmed to full on and full off only, etc. Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can use any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), clock(s), including clock(s) of any type and form, timer(s), vents, registers, etc. for residential, home, and business HVAC, televisions, radios, stereos, printers, other office equipment and appliances, projectors including projectors for display video information, data, movies, word processing, presentations, including but not limited to power point presentations and PDF files, etc., other audio-visual equipment, accessories, components, including but not limited to screens, screens that can be lowered, raised, rolled up, etc. using electromechanical ways, methods, techniques, technologies, etc. including but not limited to motors, displays including computer monitors and smart TVs including ones with remote control capability such as an IR remote control, solar devices including but not limited to solar panels, inverters and converters for solar power generation, microgrids, minigrids, off-grid, grid power, back-up power, solar blankets, solar curtains, solar windows including but not limited to smart solar windows, solar drapes, solar blinds, etc. including but not limited to smart and intelligent solar systems, devices, components, etc.

The present invention provides for lighting that is highly configurable, controllable, customizable, sensor-rich, energy communication devices and can include, among other things, but not limited to, voice command, improved security and energy savings.

Some embodiments can make buildings or all types, forms, uses, including but not limited to residential and commercial, smarter, more energy efficient with the sensors, SSL/LED lights, and controllers and other embodiments of the present invention that allow, for example, but are not limited to integrating the present invention into existing building energy management systems.

Some embodiments of the present invention enable different kinds/types of smart, intelligent lighting to be incorporated including but not limited to: daylight harvesting to prevent needless use of over lighting of sunlit and other externally artificially lit rooms and extend bulb life coupled with simple, easy installation through, for example, but not limited to, plug-and-play, constant-lumens technology. In parking lots, the present invention will prevent needless over-lighting of these by using one or more of occupancy, vacancy, ultrasonic, sonar, radar, noise, vision recognition, camera analysis, data mining, pattern recognition, etc., web cams, security cameras, inspection cameras, etc., motion sensors, etc. to ensure the parking lot or the path through the parking lot is well lit when and where it needs to be, and save energy by dimming or even turning off lights when they are not needed. Embodiments of the present invention will also help to create controllable lighting environments with adaptive and color-changing, color tuning lights that help students from elementary through professional/graduate school learn, focus, stay attentive and awake or rest when and where needed. Other embodiments of the present invention include controllable lighting for human centric, hospitals, laboratories and emergency applications and situations including but not limited to high quality health care, light therapy, light centric medical and health and healing applications, patient ability to adjust, control and be better with proper lighting, etc.

Some embodiments of the present invention can improve security and performance while saving energy and money as well as the lighting having a dramatic positive effect in improving the appearance including but not limited to lights that can change color to suit mood, dim when no one is around and turn on when motion or noise is detected.

Some embodiments include but are not limited to intelligent lighting solutions related to the control, communication, analytics, sensing and monitoring technologies that can fundamentally change the power consumption and utility of lighting systems Embodiments of the present invention can use the lights to collect a wide variety of sensor information that can be used for, for example, but are not limited to, enhancing energy savings to improving security and efficiency.

Some embodiments of the present invention allow for automatic and/or manual dimming coupled with monitoring ambient light and intelligently auto-dims in response. Dim level can also be adjusted manually or automatically including but not limited to timing, sequencing, synchronizing, etc.

Some embodiments of the present invention allow for Plug-and-Play by for example but not limited to replacing fluorescent lamps (compact, PLC, and/or linear, etc.) with SSL/LED technology is as easy as plug-and-play—no re-wiring or ballast change required making your retrofit easy and cost effective with embodiments of the present invention that can also be directly powered by AC or DC. Embodiments of the present invention allow for the lighting to be accessed on the individual lamp level through, for example, but not limited to, Bluetooth and WiFi communication pathways

Some embodiments of the present invention allow for the SSL/LED power supply and driver to produce constant lumen SSL/LED output regardless and independent of type of ballast or lack of presence of ballast (i.e., can be wired directly to AC or DC power). Embodiments of the present invention allow for two way communication with the lighting using, for example, but not limited to, computer software, servers, tablets, smartphones, or local manual controls. Some embodiments of the present invention can include and/or work with cybersecure interfaces and protocol.

In some embodiments, the operational lifetime of the SSL/LED lighting can be significantly extended with auto dimming. Unlike incandescent or fluorescent lighting, the lifetime of LEDs is not shortened by frequent switching or thermal cycles.

Some embodiments of the present invention can be configured to have autonomous control with each sensor or group of sensors interacting with the lighting autonomously, or other implementations of the present invention can be integrated into energy management systems to maximize energy savings and enhance the work environment, while providing detailed analytics and monitoring, including for marine and shipboard applications.

Some embodiments of the present invention can be tuned to wavelengths that are important to the health of employees, patients or customers. Specific wavelengths can aid in Seasonal Affective Disorder (SAD) and help regulate circadian rhythms for better sleeping.

Some embodiments of the present invention can be solar friendly and used with low-voltage DC, line-voltage AC or DC sockets, and ballasts without requiring power converters.

Again, some embodiments provide motion sensors and/or other sensors in FLRs or as external sensors which can be used to detect, track, predict etc. motion through public and/or private spaces, both indoors and out. For example, such a solid state lighting system can be used to detect unauthorized access in private areas of buildings or after-hours unauthorized access. Such a system can be used in any setting such as, but not limited to, a public and/or private building, residential home, apartment building, hotel, commercial building, shopping center, industrial building, educational building, school, entertainment center, theater, concert hall, community center, government building, park, campus, neighborhood, street, etc.

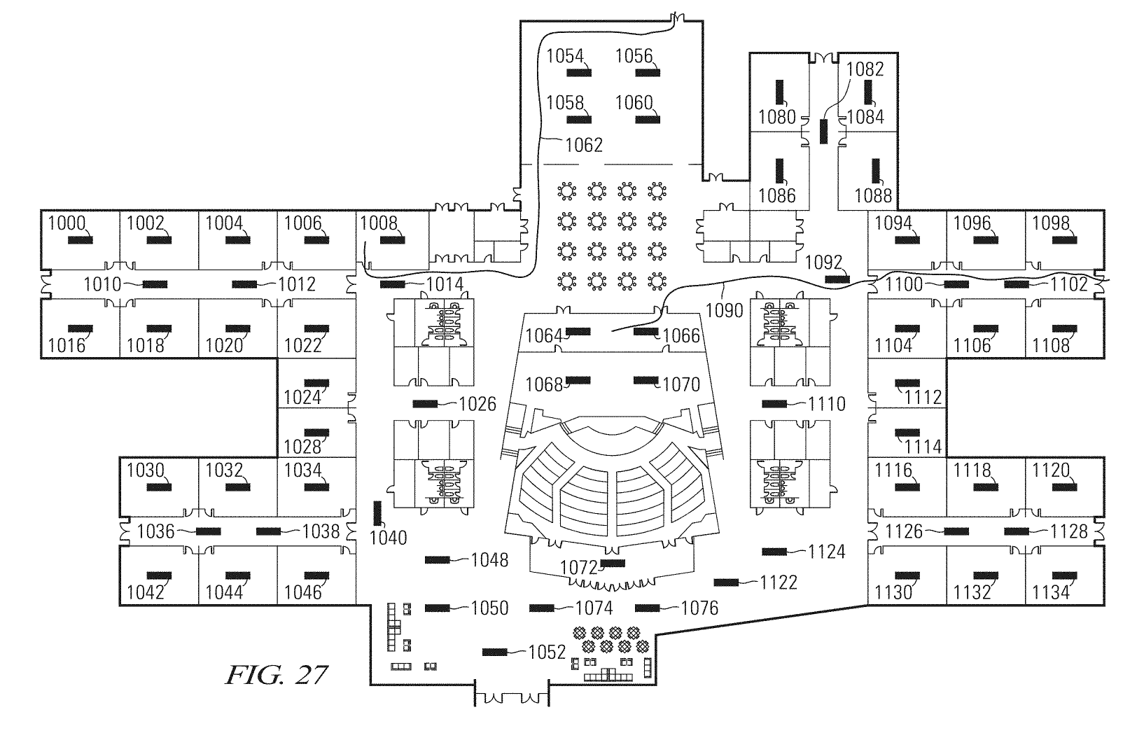

Turning to FIG. 27, an example floorplan of a building with public and private areas is shown as a non-limiting example of an application of one or more personalized lighting systems, which can be integrated with wider area lighting and sensor systems, to provide security, intruder sensing, emergency lighting and indications, etc., for example in a civic center, school, or other public building.

A northwest wing includes classrooms or meeting rooms with fluorescent lamp replacements with integrated or externally connected motion sensors 1000, 1002, 1004, 1006, 1008, 1016, 1018, 1022, 1022, accessed by a hallway with similar or identical FLRs 1024, 1028.

A southwest wing includes classrooms with FLRs 1030, 1032, 1034, 1042, 1044, 1046 accessed by a hallway with FLRs 1036, 1038.

A northeast wing includes classrooms with FLRs 1080, 1086, 1088, 1094, 1096, 1098, 1104, 1106, 1108 accessed by hallways with FLRs 1082, 1100, 1102.

A southeast wing includes classrooms with FLRs 1116, 1118, 1120, 1130, 1132, 1134 accessed by hallways with FLRs 1126, 1128.

A central area includes classrooms with FLRs 1024, 1028, 1112, 1114, a storage room or recreational hall with FLRs 1054, 1056, 1058, 1060, a lunchroom or cafeteria that can include FLRs (not shown), an auditorium or theater with FLRs 1064, 1066, 1068, 1070, 1072, and open spaces with FLRs 1014, 1026, 1040, 1048, 1050, 1052, 1074, 1092, 1110, 1124, 1122, 1076.

Again, such a floorplan and the layout and number of FLRs is merely a non-limiting example. More FLRs and/or HID replacements and/or motion sensors can be included for more precise motion detection and better coverage, including in restrooms, closets, etc.

Some areas of a solid state lighting system may be designated as authorized only at particular times, such as during business hours, during a range of time around an event, during daytime, on particular days of the week, etc. For example, access to the theater may be authorized only immediately before, during and after a public performance. When motion is detected in the theater during these authorized times, the system can be configured to ignore, or to log motion but not generate alerts or messages or other responses. When motion is detected in the theater during unauthorized times, system can be configured to track the motion and to generate an alert or message to an administrator, security personnel, law enforcement agency, etc., and/or to perform other responses, such as triggering a siren, flashing lights, strobing lights, changing color of lights, turning lights off, turning lights off except in a particular location, etc.

Some embodiments of such a solid state lighting system can also identify authorized persons based on a registry and identifications made using cellphones, Bluetooth signals, RFID tags NFC tags on security passes, or in any other suitable manner.

In an example operation, for example, if a person or animal enters through a rear door along path 1062, that motion can be detected by motion sensors in or associated with FLRs 1056, 1054, 1058, 1014, and 1008. If some or all of those areas are configured as authorized, the detected motion can be ignored, or can be logged, etc. If some or all of those areas are configured as unauthorized based on location, time of motion, or any other criteria, any suitable response can be performed by the system, for example track the motion and to generate an alert or message to an administrator, security personnel, law enforcement agency, etc., and/or to perform other responses, such as triggering a siren, flashing lights, changing color of lights, turning lights off, turning lights off except in a particular location, etc.

In another example operation, for example, if a person or animal enters through an external door in the northeast wing along path 1090, that motion can be detected by motion sensors in or associated with FLRs 1102, 1100, 1092, 1066, 1064. Again, some of those areas can be configured as authorized or public spaces, such as the hallway and cafeteria, while others can be configured as unauthorized or private spaces, such as a backstage.

In some embodiments, the system can predict motion based on the detected motion path, and can warn a person against the predicted entry into unauthorized spaces, for example using lights, lighted signs, audio warnings, etc., and/or can alert security personnel, lock doors along the predicted motion path, turn off lights or change lighting levels or colors along the predicted motion path, etc.

In some embodiments, the system can filtering out isolated false motion detections when motion cannot be tracked along a path including multiple FLR's/sensors.

The system can also be used to track motion and to turn on and off lights or change lighting colors or diming levels to guide a person or persons along a path including in case of emergency including but not limited to fire, explosion, earthquake, flood, assault, attack, lockdown, other threats, etc. All of the above applies equally to HID replacement lamps and associated hardware, fixtures, etc.

Some embodiments of the invention also include detection of opening doors or of passage through doors, which can be used for security, safety, convenience, ambiance, welcoming, alerting others within the building, etc. Lights can be turned on or brightened in the immediate vicinity of the door for the person entering, and/or in other locations to alert others to the door opening or someone passing through the door. Where entry in a door is unauthorized, alerts can be generated in response to the door opening or someone passing through the door and can be transmitted to security personnel, first responders, etc. In addition, the present invention can be tied directly to entry and exit doors and share, convey, compare, act on, alert, alarm, open, shut, lock, deactivate, not respond, make decisions, lock or unlock doors, lock intruders or bad actors into a space during a breach or threat of harm while also protecting other permitted occupants to be safely protected and locked in their respective areas as well as unlocking and allowing first responders including police to enter and apprehend the bad actor(s). Such support could include directing the first responders, especially police and peace officers and other law enforcement to the area/location/etc. of the bad actors while also knowing where the permitted occupants and other visitors, good citizens, etc. are located and whether they are safely in a secure area or not, etc.

Again, one or more personalized lighting systems can be integrated into such a detection/lighting/alert system. For example, in some cases, elements 1054, 1056, 1058, 1060 might each comprise a personalized lighting system mounted on four cubicles in a cubicle farm in the room at the top of FIG. 27, with sensor information from the personalized lighting systems 1054, 1056, 1058, 1060 feeding to an overall control system for the building, and with lighting control for emergency situations feeding back to the personalized lighting systems 1054, 1056, 1058, 1060, for example to flash their lights in an emergency situation, or to turn them off if an unauthorized intruder is detected, except perhaps for the lights closest to the detected intruder to guide emergency responders to the intruder.

Embodiments of the present invention can use one or multiple florescent or smart capable fluorescent lamp replacements that draw power from a ballast output from the ballast or AC line in a first fluorescent lamp fixture or be selectable including automatically selectable from a ballast to AC lines should the ballast fail or cease to operate properly. One or more of the smart capable fluorescent lamp replacements provides an isolated power output to components including but not limited to a control system with a peripheral interface. The peripheral interface can communicate with remote sensors including but not limited to motion, sound, light, temperature, daylight, PIR, ultrasonic, sonar, radar, voice, gesture, etc., and other devices such as, but not limited to, speakers, sirens, alarms, alerts, cameras, etc., and can power the peripherals from the isolated power output from the fluorescent lamp replacement. The sensors can be connected using wired or wireless communication. The control system with peripheral interface can communicate with other control systems or devices via one or more communications busses of any type.

Multiple smart capable fluorescent lamp replacements that can be used in personalized lighting systems can be adapted to draw power from a ballast output from the ballast or AC line in another fluorescent lamp fixture. One or more of the smart capable fluorescent lamp replacements provides an isolated power output to other smart capable fluorescent lamp replacements and to a control system with a peripheral interface. The peripheral interface can communicate with remote sensors including but not limited to motion, sound, light, temperature, daylight, PIR, ultrasonic, sonar, radar, voice, gesture, etc., and other devices such as, but not limited to, speakers, sirens, alarms, alerts, cameras, etc., and can power the peripherals from the isolated power output from the fluorescent lamp replacement. The sensors can be connected using wired or wireless communication. The control system with peripheral interface can communicate with other control systems or devices via one or more communications busses of any type, as well as with other control systems. Embodiments of the present invention can control one or more fluorescent lamp replacements, groups of fluorescent lamp replacements, other types and form factors of lights, lamps, luminaires, etc., combinations of these, etc. including ones that just have a dimming input and no other intelligence in the lamp itself.

The control systems can also communicate with one or more gateways, or aggregators, accumulators, servers, loggers, etc. that can communicate among the fluorescent lamp replacements, the sensors, themselves, to other servers including but not limited to a central server, a laptop, a desktop, other devices including but not limited to smart phones, tablets, personal digital assistants, mobile carriers, cloud-based systems, WiFi networks, etc.

Based upon the disclosure herein, one of skill in the art will recognize that any number or combination of smart fluorescent lamp replacements in any variation can be networked or connected with control systems, gateways, remote sensors, peripherals, networks, etc. in an endless variety of configurations based upon the application and requirements. This includes having more than one smart lamp, one of more follower lamps that accept a dimming signal (which could be analog, digital or both or of any other type) and respond accordingly.

Personalized lighting systems can include multiple control panels, power sockets and relays, FLRs and control interfaces in accordance with some embodiments of the invention. In such embodiments, a controller can receive power from an AC line and/or ballast output at line/neutral inputs. The controller performs voltage regulation and provides a low voltage output that can be used by external components, devices, sensors etc. such as, but not limited to, wall switches or wall plates and relays, etc. Power sockets provide AC line power, switched under by relays under control of the controller. For example, controller can use a digital buss or any other wired or wireless network or system to send and/or receive commands or information to relays or other devices, such as receiving on/off, dimming, motion sensing, or other information from wall plates. Power sockets can provide any desired output voltage or current, such as, but not limited to 120 VAC in some sockets, 277V for lights, etc. The controller can be implemented using any form factor, such as, for example, in a small housing adapted to be mounted in an electrical junction box, power gang box, switch box, etc., or on a wall or in any other desired location.

In some embodiments, relays which can be but are not limited to low voltage latching relays, can be used and, for example, but not limited tom each being addressable on the digital buss to receive commands from a controller which could be a computer, server, smart phone or tablet, etc., powered by, for example but not limited to the low voltage output from the controller to perform any desired switching, such as but not limited to switching an AC line running to sockets. Relays can also be used to directly power a solid state light under commands from the controller, or can be used to control or power other loads including but not limited to AC line, DC, ballasts with associated FLRs with internal and/or external wired and/or wired interfaces.

An interface to the controller can be provided in any suitable manner, such as but not limited to using a server with one or more communications interfaces. Non-limiting examples of such interfaces to server include smart phones or tablets, wireless motion detectors, wired motion detectors, wireless DLH, wired DLH, wireless IOT devices, wired IOT.

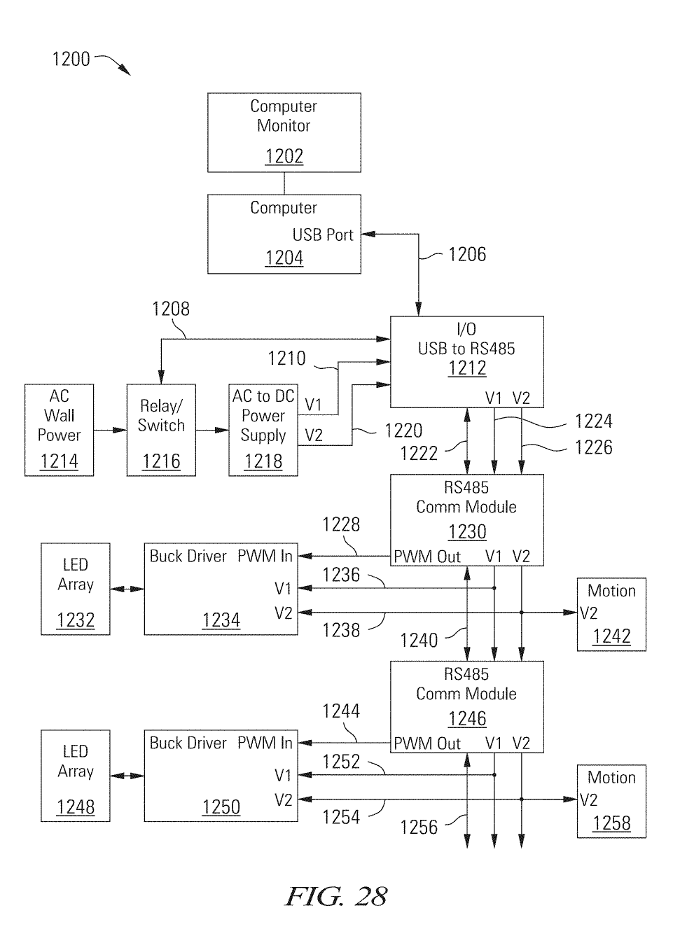

Turning now to FIG. 28, a non-limiting block diagram of a personalized illumination system 1200 is depicted in accordance with some embodiments of the invention. One or more personalized lighting systems can be controlled for example by one or more wired and/or wirelessly connected control or computing devices, such as, but not limited to, a computer system 1204, 1202 with USB connection 1206. A USB to RS485 or other bus converter and/or I/O interface 1212 can be used to interface between the computer system 1204, 1202 and personalized lighting systems, which can, for example but not limited to, include a command/control bus such as an RS485 bus 1222, 1240, 1256 using RS485 modules 1230, 1246 to receive/transmit commands and status information via the RS485 bus 1222, 1240, 1256 or other bus or signals. Power for one or more personalized lighting systems can be generated by a power supply such as, but not limited to, one including an AC wall power input 1214, relay/switch 1216 to controllably cut power to the system, and an AC to DC power supply 1218, which in some cases is configured to generate more than one voltage, such as a voltage V1 1210 and a voltage V2 1220, for example a lower voltage (e.g., 3V, 5V, etc.) to power electronics in the system, motion sensors 1242, 1258 or other sensors, etc., and a higher voltage (e.g., 12V, 24V, 48V, etc.) to power solid-state lights in the system. The relay/switch can be, for example but not limited to, any type of relay including but not limited to latching, non-latching, electromechanical, vacuum, coil, one pole or more than one pole, one throw or more than one throw, of any appropriate type, material, form, design, implementation, construction, etc. Likewise the switch, if used, can be of any type, material, structure including but not limited to semiconductors, vacuum tubes, etc. including but not limited to those herein. In some embodiments of the present invention, step down or step up voltage converters can be used to internally generate other voltages from, for example but not limited to, V1 1210 and/or V2 1220. For example, but not limited to, one or more voltages lower or higher than V1 can be generated, for example but not limited to USB to RS485 or other bus converter and/or I/O interface 1212, computer system 1204, 1202, command/control bus such as an RS485 bus 1222, 1240, 1256 using RS485 modules 1230, 1246 as well as the power supplies, drivers, lighting, etc., combinations of these, etc. Although the power supply in FIG. 28 is shown with 2 outputs, V1 and V2, respectively, any number of outputs including 1 or higher can be used as appropriate and needed. Such converters could consist of switching or linear regulators including but not limited to those mentioned herein as well as elsewhere. The particular arrangement of blocks and what is contained in each block is non-limiting in any way or form and is intended as non-limiting illustrative examples of the present invention.

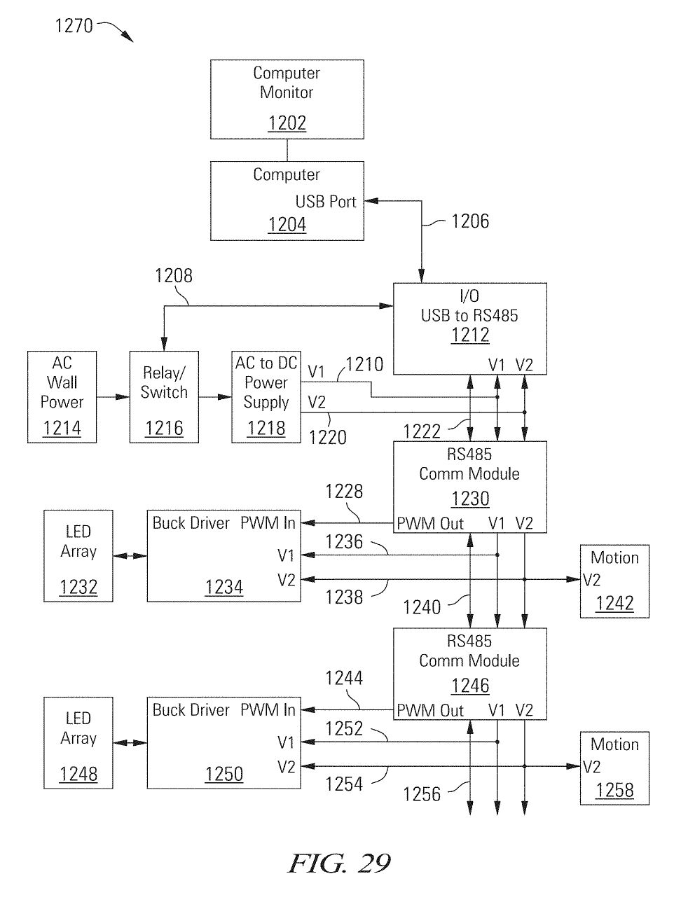

Turning now to FIG. 29, a non-limiting block diagram of a personalized illumination system 1270 is depicted in accordance with some embodiments of the invention. One or more personalized lighting systems can be controlled for example by one or more wired and/or wirelessly connected control or computing devices, such as, but not limited to, a computer system 1204, 1202 with USB connection 1206. A USB to RS485 or other wired or wireless or combination of both bus converter and/or I/O interface 1212 can be used to interface between the computer system 1204, 1202 and personalized lighting systems, which can, for example but not limited to, include a command/control bus such as an RS485 bus 1222, 1240, 1256 using RS485 modules 1230, 1246 to receive/transmit commands and status information via the RS485 bus 1222, 1240, 1256 or other bus or signals. Power for one or more personalized lighting systems can be generated by a power supply such as, but not limited to, one including an AC wall power input 1214, relay/switch 1216 to controllably cut power to the system to, for example but not limited to, reduce or eliminate standby power, and an AC to DC power supply 1218, which in some cases is configured to generate more than one voltage, such as a voltage V1 1210 and a voltage V2 1220, for example a lower voltage (e.g., 3V, 5V, etc.) to power electronics in the system, motion sensors 1242, 1258 or other sensors, etc., and a higher voltage (e.g., 12V, 24V, 48V, etc.) to power solid-state lights in the system.

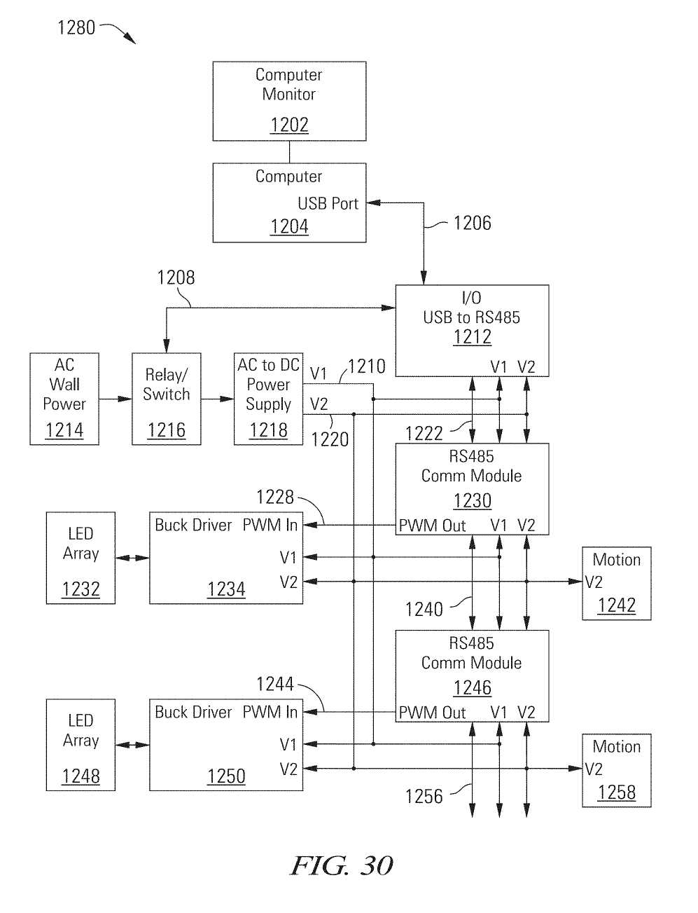

Turning now to FIG. 30, a non-limiting block diagram of a personalized illumination system 1280 is depicted in accordance with some embodiments of the invention. One or more personalized lighting systems can be controlled for example by one or more wired and/or wirelessly connected control or computing devices, such as, but not limited to, a computer system 1204, 1202 with USB connection 1206. A USB to RS485 or other wired or wireless or combination of both bus converter and/or I/O interface 1212 can be used to interface between the computer system 1204, 1202 and personalized lighting systems, which can, for example but not limited to, include a command/control bus such as an RS485 bus 1222, 1240, 1256 using RS485 modules 1230, 1246 to receive/transmit commands and status information via the RS485 bus 1222, 1240, 1256 or other bus or signals. Power for one or more personalized lighting systems can be generated by a power supply such as, but not limited to, one including an AC wall power input 1214, relay/switch 1216 to controllably cut power to the system to, for example but not limited to, reduce or eliminate standby power, and an AC to DC power supply 1218, which in some cases is configured to generate more than one voltage, such as a voltage V1 1210 and a voltage V2 1220, for example a lower voltage (e.g., 3V, 5V, etc.) to power electronics in the system, motion sensors 1242, 1258 or other sensors, etc., and a higher voltage (e.g., 12V, 24V, 48V, etc.) to power solid-state lights in the system.

A driver such as a buck driver 1234, 1250 can be provided for each personalized illumination system, receiving the one or more voltages 1236, 1238, 1252, 1254 and a PWM control signal 1228, 1244 from the RS485 modules 1230, 1246 to control an output current to an LED array 1232, 1248 or other solid-state light or other light sources. It should be understood that a buck driver is only one of many possible choices; other choices include but are not limited to Boost, Buck-Boost, Boost-Buck, Cuk. SEPIC. Flyback, forward converter, forward current mode converter, forward voltage mode, push-pull, high-side/low side, other types of switching and/or linear converters including but not limited to those discussed herein and elsewhere, combinations of these, etc.

In some embodiments, such as those depicted in FIGS. 29-30, the AC to DC power supply 1218 can provide the output power signals directly to the RS485 modules 1230, 1246 or to other components of the system. In other words, in various embodiments, power and/or other signals can be relayed through other components of the system or can be provided along shared rails or conductors.

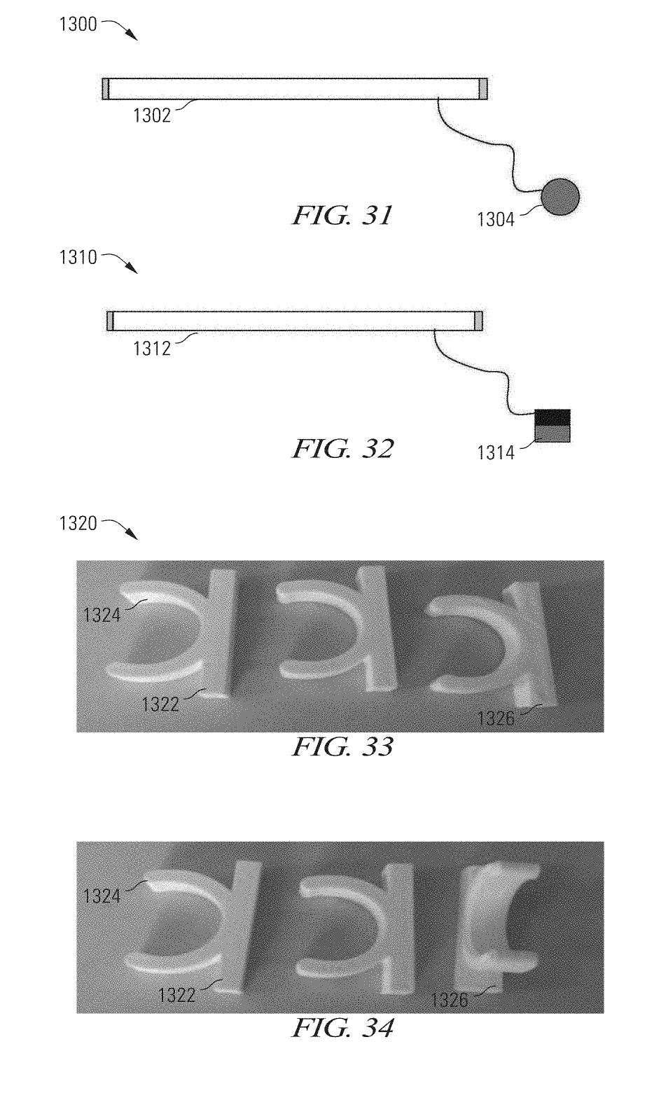

FIG. 31 depicts a lighting system 1300 with a solid state replacement 1302 for a fluorescent lamp, with an external motion, light, or color sensor or other device 1304 in accordance with some embodiments of the invention.

FIG. 32 depicts a lighting system 1310 with a solid state replacement 1312 for a fluorescent lamp, with an external electronic device 1314 powered by the solid state lamp replacement in accordance with some embodiments of the invention.

FIG. 33 depicts a side view of a set 1320 of three example mounting clips (e.g., 1322, 1326) for mounting a diffuser to a solid state lamp replacement in accordance with some embodiments of the invention. The clips can be adapted to any form factor of lamp, any attachment device such as, but not limited to, the curved arms 1324 which are adapted to snap over a cylindrical solid state lamp. A flat mounting surface or other suitable mounting surface or member such as that illustrated can be provided to mount a diffuser adjacent the solid state lamp using any suitable attachment mechanism, such as, but not limited to, adhesives, snaps, grooves, slides, slots, magnets, screws, etc.

FIG. 34 depicts the three mounting clips of FIG. 33, with a bottom view of one of the clips.

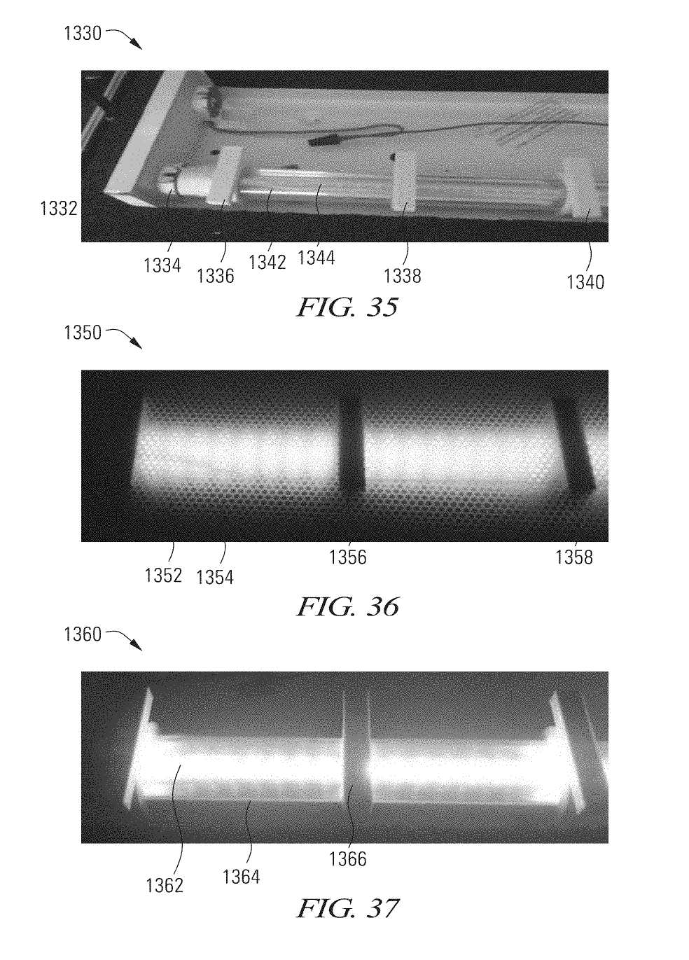

FIG. 35 depicts a solid state lighting system 1330 for a fluorescent lamp fixture 1332 with three example mounting clips 1336, 1338, 1340 connected to a solid state lamp replacement 1340 which can include one or more LEDs (e.g., 1344) or other solid state light sources of any type, which can be mounted in the fixture 1332 for example at tombstones (e.g., 1334) or other mounting points, before attaching a diffuser to the clips, in accordance with some embodiments of the invention.

FIG. 36 depicts a fluorescent lamp fixture 1350 with an example diffuser 1352 mounted to a solid state lamp replacement with a number of clips (e.g., 1356, 1358) in accordance with some embodiments of the invention. In this example, the diffuser 1352 includes a number of holes or openings (e.g., 1354) which can have any shape and size and which can be distributed in any pattern or arrangement to allow light to pass therethrough.

FIG. 37 depicts a fluorescent lamp fixture 1360 with another example diffuser 1364 mounted to a solid state lamp replacement 1362 with a number of clips (e.g., 1366) in accordance with some embodiments of the invention.

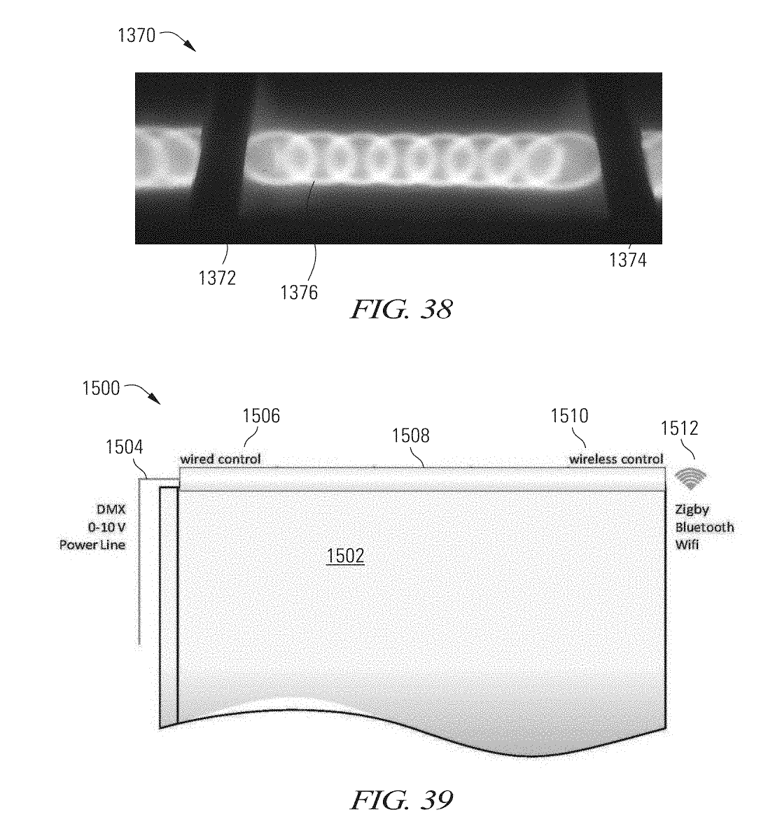

FIG. 38 depicts a fluorescent lamp fixture 1370 with another example diffuser 1376 mounted to a solid state lamp replacement with a number of clips (e.g., 1372, 1374) in accordance with some embodiments of the invention. Any type of diffuser can be mounted to a solid state lamp replacement, such as, but not limited to, diffusers operating through material opacity, material structure or arrangement such as diffraction or lensing, patterning, openings or holes, reflectors, etc., and can be made of one or more of any material, with any shape, such as, but not limited to, flat, curved, or any other shape.

FIG. 39 depicts a side view of a cubicle 1502 or other partial wall with a solid state luminaire 1508 in accordance with some embodiments of the invention. The luminaire 1508 can be controlled by one or more control interfaces, such as, but not limited to, wired (e.g., DMX, 0-10V, powerline, or other wired interfaces discussed herein) 1504, 1506, and/or wireless (e.g., Zigby, Bluetooth, WiFi or other wireless interfaces discussed herein) 1510, 1512.

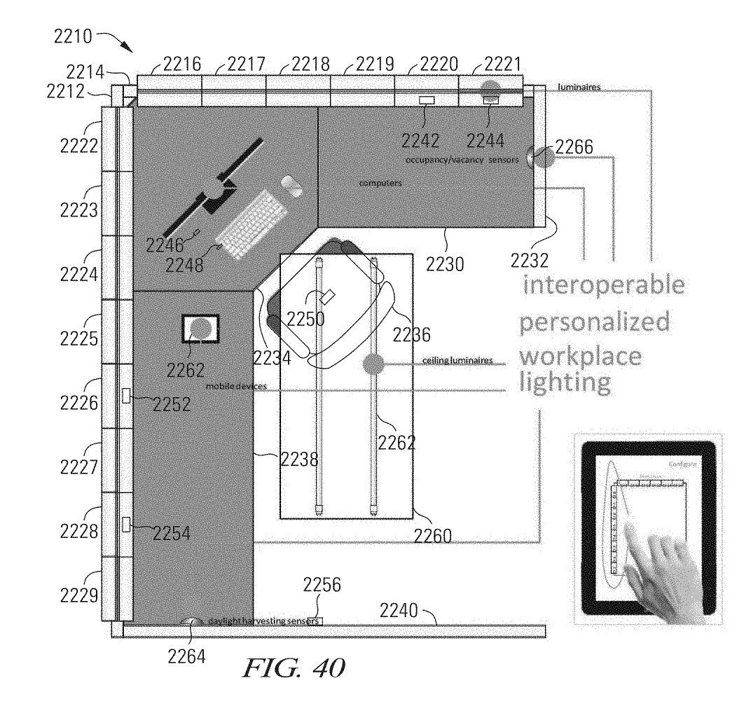

FIG. 40 depicts a top view of a cubicle office space with a personalized direct work surface illumination system and with a ceiling mounted fluorescent lamp fixture with optional solid state lamp replacements in accordance with some embodiments of the invention. The cubicle office space 2210 is depicted with a personalized direct work surface lighting system in accordance with some embodiments of the invention. In this example, cubicle is formed by three full cubicle walls 2212, 2214, 2240 and a partial cubicle wall 2232 leaving a door or entry space, enclosing three desk surfaces 2230, 2234, 2238 and chair 2236. A personalized lighting system is installed on the top of cubicle walls 2212, 2214 to illuminate the desk surfaces 2230, 2234, 2238, including light modules or strips 2216, 2217, 2218, 2219, 2220, 2221, 2222, 2223, 2224, 2225, 2226, 2227, 2228, 2229. The light modules 2216-229 can be easily mounted to the cubicle walls 2212, 2214, for example with width-adjustable clamps, can be connected to one another, for example by sliding modules together so that power rails and control signal and/or data bus rails are connected between modules. The light modules 2216-229 can be provided with reflectors and diffusers, etc., as depicted in various Figures herein, as well as variations thereof. Based upon the disclosure provided herein, one of ordinary skill in the art will recognize a variety of combinations of features from different embodiments disclosed herein that can be used in a personalized lighting system for both/either direct work surface illumination (which by definition herein can include reflectors), and/or indirect illumination such as, but not limited to, directing light toward the ceiling to provide ambient lighting. Again, vertical, tilted, manually, automatic or remote tilting or angular adjustment from the vertical or normal or horizontal, etc. can be included in embodiments and implementations of the present invention. Furthermore, the personalized lighting system can be configured to provide customized lighting to just one or to both sides of a cubicle wall or other barrier, for example lighting work spaces on both sides of a cubicle wall, lighting a work space on just one side of a cubicle wall without lighting the other side, or providing direct work surface illumination on one side of a cubicle wall and more general indirect lighting to the other side of the cubicle wall, such as to a corridor or aisle running along the other side of the cubicle wall, etc.

The personalized lighting system can work in conjunction with an area lighting system such as, but not limited to, a dimmable solid state lamp replacement 2262 in a fluorescent light fixture 2260, which can have a diffuser mounted thereto, for example using diffuser mounting clips that attach directly to the dimmable solid state lamp replacement 2262. The system can be controlled, for example, by a computer 2246, mobile device 2262, sensors 2266, 2264, etc.

In some embodiments, motion and/or light or other sensors can be integrated in the personalized lighting system, for example including occupancy or vacancy sensors, such as but not limited to motion sensors of any type and form including but not limited to infrared, PIR, ultrasonic, microwave, proximity, sonar. RF, transducers and sensors, wearable and other device proximity, etc., combinations of these, etc., on one or more of the cubicle walls 2212, 2214, 2232, 2240, and/or on or under the desk 2230, 2234, 2238, etc. If, for example but not limited to, no motion and/or occupancy has been detected in the cubicle for a predetermined period of time, for example, the personalized lighting system 2210 can be dimmed or turned off, and turned on or up when, for example, but not limited to motion/occupancy is detected in the cubicle. Light sensors in the cubicle can be used to control dimming or power levels in the personalized lighting system to yield a desired lighting level on the desk 2230, 2234, 2238. One or more occupancy/vacancy sensors (e.g., 2244, 2246, 2248, 2250, 2252, 2256) can be included in some embodiments of the system, connected to, for example but not limited to, light fixtures, cubicle structures, or elements within the cubicle, to computers/monitors/keyboards, to chairs, etc. One or more daylight harvesting sensors (e.g., 2242, 2254) can also be included in some embodiments of the system, connected to, for example but not limited to, light fixtures, cubicle structures, or elements within the cubicle, to computers/monitors/keyboards, to chairs, etc. Such sensor information can further be provided to users through a user interface, including but not limited to alerts or messages to the user via networked computer, text messages or other alerts on a smartphone or other portable device, etc. Implementations of the present invention can also control other devices, circuits, wall or other power, AC or DC power, power outlets, etc.

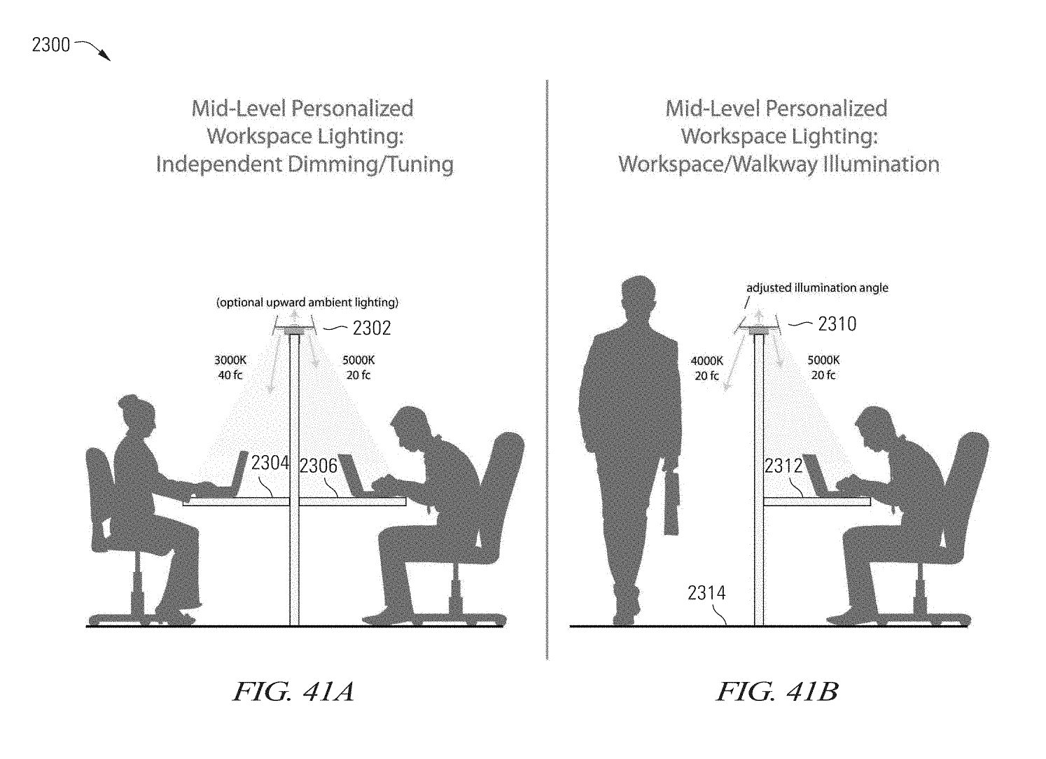

FIG. 41A depicts an end view of a workspace 2300 with a cubicle or other partial wall with a solid state luminaire 2302 providing task lighting to work spaces 2304, 2306 on either side of the wall in accordance with some embodiments of the invention.

FIG. 41B depicts an end view of a cubicle or other partial wall with a solid state luminaire 2310 providing task lighting to a work space 2312 on one side of the wall and to a hallway or other area 2314 on the other side of the wall in accordance with some embodiments of the invention. The solid state luminaire 2310 provides lighting that is controllable by one or more user interfaces to provide the desired lighting to various areas, which can be controlled in conjunction with light levels from other light sources (e.g., area lights and/or windows) based on sensors, or based on dimming control of the other light sources, so that the desired lighting level can be provided where needed with lower overall energy consumption and wasted lighting where it is not needed. The solid state luminaire 2310 can also be responsive to the presence of occupants or passersby, can be controlled based on the time of day, day of week, etc., to emergency conditions, or to any other local and/or remote conditions or stimuli or power conditions.

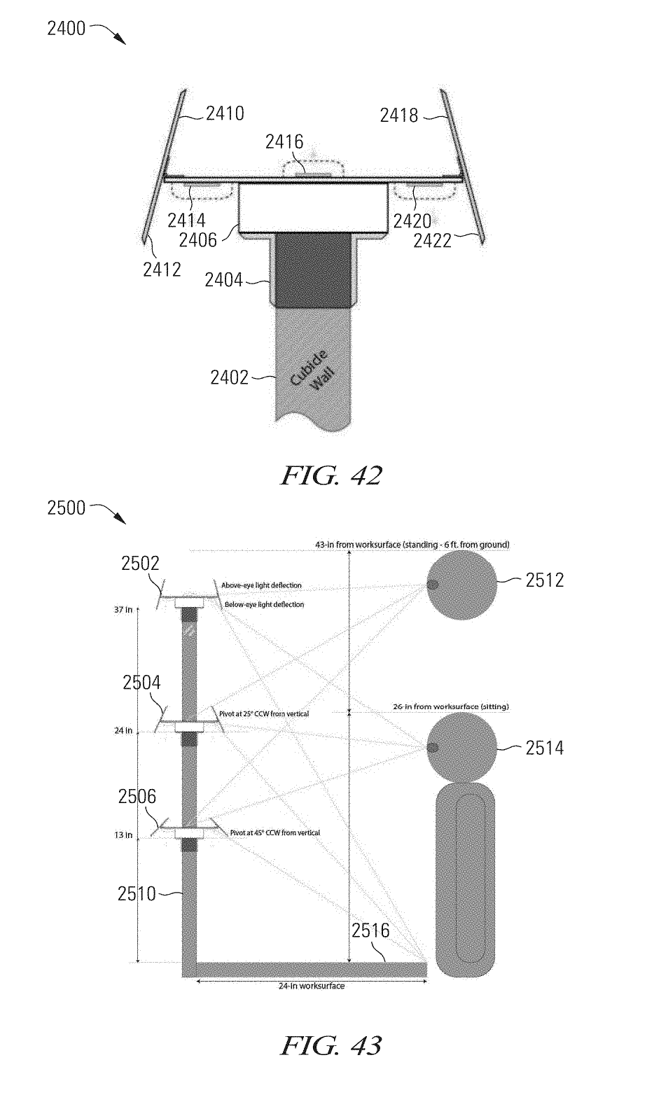

Turning to FIG. 42, a personalized illumination system 2400 is depicted with optional glare deflectors 2410, 2412, 2418, 2422 and diffusers over light sources 2414, 2416, 2420 in accordance with some embodiments of the invention. Electronics controlling/powering/driving the light sources (e.g., 2414, 2416, 2420) can be provided in any suitable location, such as in an electronics housing 2406 in the personalized illumination system 2400. The personalized illumination system 2400 can include a mounting assembly with a fixed or variable-width clamping mechanism 2404 or other mounting hardware which can be used to mount the personalized illumination system 2400 to a cubicle wall 2402 or any other suitable mounting surface.

FIG. 43 depicts an end view of a lighting system 2500 with one or more personalized illumination systems 2502, 2504, 2506 mounted at various possible and example points on a wall or mounting surface 2510, illustrating illumination at various locations 2512, 2514 in accordance with some embodiments of the invention. The lighting system 2500 provides controllable and flexible lighting at a work surface 2516 for a seated occupant 2514 or standing person 2512, providing controllable illumination levels, temperatures, colors etc. at various locations, optionally in conjunction with controllable light from other light sources.

The present invention can respond in a number of different modes to a given situation. This includes but is not limited to turning the overhead, ceiling, wall, other, etc., general lighting fixtures to a lower (dimmed) level. Turning up some or all of the overhead, ceiling, wall, other, etc., general lighting fixtures when motion is detected that indicates one or more persons are leaving a personalized area as well as turning down or off certain electrical power, outlets, receptacles, appliances, personal HVAC including but not limited to fans, heaters, warmers such as but not limited to foot warmers, personal exercise equipment including but not limited to foot warmers, walking machines, tread mills, other types of exercise machines, etc., combinations of these, etc., the lighting in the personalized space including but not limited to cubicle space(s) can be of any color temperature, color, etc., one or more color temperatures, one or more colors, more than one color temperature, more than one color and can consist of one or more lighting sources including but not limited to desk lamps, task lamps, under shelf lamps and lighting, wall lighting, cubicle lighting, suspended lighting, lighting attached to desks, tables, cubicles, suspended lighting, light suspended from surfaces, etc., combinations of these, etc.

The present invention provides among other things communication and coordination between the lighting sources in a room, personalized space, cubicle, office, open space, shared space, library space, library study areas, hospital and clinic, classrooms, open spaces, including but not limited to single, individual, personalized, group, shared, etc. space(s) that allows increased efficiency, enhanced comfort and quality of environment including but not limited to lighting, HVAC, air quality, physical and psychological comfort, productivity and well being.

The coordination can include the personalized lighting detecting occupancy and/or vacancy of spaces, transitions from/to/between spaces, etc., combinations of these, etc. and adjust the light appropriately depending on the specifics of the space and the users which could dimming the overhead, etc. so as to not result in a cave effect yet be low enough that the personalized is dominant thus providing higher energy efficiency coupled with personal preferences and choices including but not limited to lighting, air flow, temperature, humidity, etc.

The present invention can use wireless communications including but not limited to WiFi, LiFi, Bluetooth, BLE, Zigbee, ZWave, LoRa, 6LoWPAN, Thread, IPv4, IPv6, IEEe80X, etc., wired including but not limited to 0 to 10V, DMX, DMX512, DALI, USB, Serial, RS485, RS232, variants of these and other digital and analog wired protocols, interfaces, etc. as well as powerline communications, etc., and combinations of these. etc. others discussed, herein, combinations of these to communicate and also provide hot spots, video streaming, internet, web, cloud based communications, services, transitions, receiving, etc. and for other communications purposes.

The present invention can provide protection, security, including but not limited to air quality, pollution, airborne detection, gas detection, thermal detector/imagers, breaking glass detector, motion detection, humidity, carbon monoxide levels, carbon dioxides when no persons should be working, in the space, studying, occupying the spaces(s), being in the spaces, etc.

The present invention can be set/programmed/controlled to perform certain functions upon detection of motion including but not limited to be a coordinator of motion detection response including but not limited to turning some light on, dimming or turning off other lights, etc. when motion and/or occupancy is detected or the lack of motion and/or occupancy is detected/determined in which case certain lighting is turned off/dimmed, etc., certain parts or all of the HVAC, other environment-related systems, power, outlets, receptacles, etc. are turned off or lowered as the case may be. In other circumstances such as but not limited to when the building is empty of employees, office workers, students, staff, faculty, other persons who should normally not be there, etc. and/or, depending on the type of building, facility, office and use, after hours or on the weekends or set in a mode to be in protection/protective/security, etc. Embodiments of the present invention can go into a defensive mode and provide protection and security by, for example, using the motions, occupancy, vacancy sensor, other sensor, cameras, infrared imagers, IoT, glass break sensors, water leak detectors, moisture detectors, speakers, microphone(s), etc., to detect intruders or thought-to-be intruders. Such detection can include but is not limited to tracking, logging, analyzing, using artificial intelligence (AI), etc. In some embodiments of the present invention, the system can turn the lights on, use the lights to follow the one or more intruders, flash the lights on and off, strobe the lights at frequency or frequencies that are disturbing/distracting, cause temporary unpleasantness, disorientate, disturb, etc., or stay off and display or indicate no signs of detection while providing silent alerts remotely to the police, the office manager, the information technology (IT) personnel and/or department, the building manager, the building owner, the general manager of the building and/or business, etc. and then either remain silent or start to flash, strobe, change color, activate one or more sirens, speakers, cameras including security cameras, lock down the building, trigger other services, etc., one or more combinations of these, etc. Embodiments of the present invention can also be used for other types of protection including but not limited to fire, earthquake, flood, After the first responders, police, fire department, ambulance(s), the lights could them, for example, but not limited to turn on and leading the first responders, others, etc. to the intruders, flashing the lights above, near to embodiments of the present invention. etc. to assist in reaching the persons and, for example, but not limited to if there is one or more intruder(s), flashing and/or strobing the lights at the location(s) of the intruder(s), turning on speakers to alert the intruder(s) of the presence of the first responders, turn on piercing sirens, speakers, loud speakers, public assistance (PA) speakers, put out blinding light, put out high decibel sounds, noise, etc.

Embodiments of the present invention can be controlled and monitored by/via building automation system (BAS) software including but not limited to BAS, BACNET, LonNET, by Windows, iOS, code and software running on one or more of pc(s), server(s), laptop(s), computer(s), desktop computer(s), etc., one or more of these, combinations of these, etc. to control, monitor, respond, etc.

The sensors and other IOT can be mounted/installed in any practical location and locations.

Embodiments of the present invention can use sensors and IOT, controls, interface circuits, etc., that are powered by but not limited to the lighting, by AC power, by converted AC power, by battery, by proximity, by super capacitors, by the sun, by solar, by wind, by geothermal, by energy harvesting, by mechanical energy harvesting, by mechanical movement, by battery charging, by super capacitor charging, by other forms of alternative energy, etc., by combinations of these, etc.

Embodiments of the present invention can also talk, communicate, interact with thermostats and other types of HVAC controls as part of the lighting detection, comfort, energy savings, personalized enhanced choices and decisions, etc. The thermostat or other type of temperature controller/monitor may also be part of the sensor and/or IOT network of embodiments of the present invention.

The users of the present invention may communicate, interact, control, monitor, etc. via a local area network (LAN) that talks/communicates with other computers, servers, the web, the internet, the cloud etc.

Embodiments of the present invention may use, control, interact with any type of lighting and use and control any type of light, lighting, lamp, fixture that is powered in any way or form including but not limited to AC line, ballast, ballast of any type or form including electronic, magnetic, instant start, rapid start, programmed start, power over Ethernet (POE), solar, alternative energy, low voltage, DC, high voltage, pulsed, etc., combinations of the above, other types of power and energy, wireless power, etc.

Embodiments of the present invention may contain and communicate via light fidelity (LiFi).

Solid state lighting is much more efficient than traditional lighting sources, but has still had very low levels of acceptance due to the need to replace or retrofit existing fixtures. Part of the reason for resistance in linear LED adoption is the difficulty and expense of working with or around the ballast, which adds a layer of engineering complexity for achieving intelligent lighting. For example, the early “plug-and-play” LED lighting options for linear fluorescent replacements have two key problems: 1) they do not always produce equal brightness between different ballasts, leading to aesthetic and maintenance problems and 2) they have not been dimmable or tunable because the ballast interrupts the control signal, leaving users with lighting levels that cannot be changed. Thus, even though converting to LED can save 50% in energy costs over linear fluorescent lighting, adoption has been greatly slowed from poor options: 1) use plug-and-play lighting that cannot be dimmed or tuned, or 2) simply replace or retrofit the fixture with a dimmable/tunable LED solution, which is high in both materials and labor costs.

Ceiling-based lighting has the benefits of illuminating a full workspace but has two significant disadvantages: 1) it forces a “one-size-fits-all” brightness and color temperature or color upon people in spaces with multiple workers, causing discomfort and productivity losses, and 2) it illuminates from an unnecessarily high distance from the work surface, consuming power-law (i.e. r^{x} where x=2 for a point source and often <2 for other types of light sources) more light radiant energy than would be required with a closer distance (e.g., four times more energy at twice the distance for the same illuminance, again, for a point source). The contrast to ceiling-based lighting—task lighting—consumes less energy from closer illumination distances but has its own disadvantages including but not limited to: 1) it creates “spotting” and “cave effects” by illuminating only portions of the work surface, 2) is not useful if a space is over-lit by ceiling-based lighting, 3) may not provide adequate safety illumination if used as the only light source, 4) occupies precious workspace and can be inadvertently moved from its desired position. The ability to dim ceiling-based lighting helps but does not completely solve the workspace (e.g., cubicles) lighting problem; ceiling fixtures rarely perfectly align over workstations, leading to inconsistent illumination at each workstation. Additionally, even with dimmable ceiling-based lighting, human resources (HR) problems and issues have resulted from differences in brightness, color temperature, color, etc. preferences in multi-worker areas, resulting in slower adoption of technologies that could significantly reduce energy consumption.

The solid state luminaire lighting disclosed herein provides profound commercial and/or residential energy savings, with high adoptability appeal, that solves the conflict between ceiling-based lighting and task lighting. This technology accomplishes the super-linear/power-law energy savings of closer illumination distances, provides full work surface illumination, can illuminate surrounding walkways, and is able to communicate with ceiling-based and other lighting as well as other systems including HVAC, etc., for coordinated efficiency. It can include a or be provided as a modular luminaire that utilizes existing workspace structures, such as cubical walls as well as open-space workspaces and workstations, for maximum ease of implementation. In some embodiments, the fixture modules fit together electrically and mechanically, coordinate control, and span part or the full length of one or more sides of a workstation area. For higher adoptability, the hardware can be self-commissioning, can plug into common receptacles, can have upgradeable firmware, and can be controlled via an interoperable software suite to optimize lighting personalization and experience. Some embodiments include one or more separate SSL (i.e., LED) arrays that, for example, can point in different directions and/or be of different colors or color temperatures and be optionally configured in a sleeping LED array configuration to allow different light intensities and, in some cases, different color or color temperatures to illuminate different areas of the work space (i.e., cubicle, interior walls, ceilings, other work spaces, non-work spaces, etc.). Some embodiments employ optical beam steering of the light. OLEDs can also be used.

As mentioned above, lighting distance from the work surface is a key factor for determining required wattage and light utilization; for example, cubicle walls, at common heights 42″ (13″ from work surface), 53″ (24″ from work surface), and 66″ (37″ from work surface), provide an existing structure from which to achieve closer illumination distances, power-law saving over 70% in energy compared to 9-ft. ceiling illumination, even when compared to ceiling-based LED lighting. Cubicle walls surround approximately 3.6B ft² of worker space in the US (based on a reported 40 Million Americans working in cubicle spaces and 90 ft² per cubicle space) and occupy 23% of office space; 19% of commercial energy consumption is attributed to office space. Additionally, as 93% of cubicle workers are unhappy with their work environment, improving the lighting situation (better light quality, dimmability, color tuning, and other personalization) over the current on/off ceiling illumination status quo is a very welcome and productive proposition that can be speedily and readily adopted.

Some embodiments of the solid state luminaire lighting system coordinate with ceiling lighting, which can comprise, but is not limited to, a dimmable Type A (ballast compatible) LED linear fluorescent lamp replacement, which compatible with standard non-dimmable ballasts. This dimmable/controllable lamp-based solution is significantly less expensive than alternatives (e.g., fixture replacement) and provides greater energy savings from dimming and coordination with sensors. This can play an important role in coordinating optimal-efficiency illumination with personalized workspace lighting. For example, in a multi-worker cubicle space, the ceiling lighting could be dimmed to a common low level sufficient for safety, while the main source of workspace illumination comes from the luminaires. In emergencies the ceiling could be programmed to go to full brightness.

The solid state luminaire lighting system can use personalized lighting as the primary source of light. Workers can illuminate their personal workspaces without imposing their preferences on others. Workers can dim, adjust color temperatures or full color spectrum, and program their lighting in a way that makes them most comfortable and productive. Super-linear, power-law (e.g., the square of the reduction in distance for point source-like lighting) energy savings are realized from closer illumination proximity, and the system can coordinate with sensors including Internet-of-Things (IoT).

One or more control systems or controllers, for example embodied in a control circuit or in software on computers, mobile devices, servers, etc., can be used to control the solid state luminaire lighting system. Software for configuration, control, and analysis gives users the ability to easily adjust lighting parameters, integrate the system with sensors to enable automatic adjustments, and allow users to create user profiles such that their preferred setting are saved. Some embodiments provide open-source interoperability and allow future advance analysis and building-management-system integration and building-automation-system (BAS) compatibility.

The solid state luminaire lighting system can use any suitable wired and/or wireless communication protocols such that the system can integrate with modern sensors (daylight harvesting, occupancy/vacancy, temperature, etc.), controls (e.g., mobile devices, desktop or laptop computers, desktop controls, etc.), other light sources, and building management systems. The system integrates control of overhead and task lighting. Some embodiments are configured with self-commissioning of the lighting system on existing workspace structures, eliminating the need for expensive ceiling-based wiring to make lighting control and sensing more granular. The system allows interoperability with other technologies, including other light sources, sensors, and software, allowing for greater efficiency and system utility (e.g., sensors can double for security monitoring during off-hours, provide information to HVAC, provide demand response (DR) load shedding, etc.). As illustrated in the Figures, the solid state luminaire lighting system provides interoperability between personalized and area lighting and can control and direct light (through both mechanical and electrical means) to achieve area- and height-specific illumination, minimizing the required energy and maximizing individualization.

The solid state luminaire lighting system provides several economic benefits: 1) dramatic energy savings of typically up to and over 70% compared to ceiling-based LED lighting; 2) the system is easily reconfigurable, giving lighting flexibility for different users (imagine, for example, in call centers where workers change spaces regularly) or groups (IT, accounting, engineering, sales, etc.) without the cost of facilities personnel or electricians adjusting or changing the lighting; 3) it gives companies greater flexibility in where they can place workspaces, as solid state luminaire lighting is affixed to the workspace, not the ceiling; 4) potentially improved worker productivity (which has been has been measured to be as much as 13 times as valuable as energy costs.) from a more comfortable/efficient work environment; and 5) potentially reduced employee turnover.

The solid state luminaire lighting system gives users greater control of their lighting experience (dimming, color tuning, scheduling, sensor thresholds), which has thus far largely been limited to on/off switching in the commercial and industrial sectors, affects the comfort level and productivity of users and can have an effect on other issues, including health issues such as Seasonal Affective Disorder and circadian rhythm cycle regulation.

Other industries outside of office workspaces can also benefit from the solid state luminaire lighting system, such as the restaurant and industrial industries where people spend time in a local space as well as libraries and other study/work spaces. Also, the power of a robust intelligent lighting system that can affect the commercial and industrial built environment has another powerful benefit: the foundation for a smart building. Lighting fixtures in these environments are 1) ubiquitous and 2) powered, which provides the best first step for both energy savings and installing a sensor network that can be used for other benefits, such as greater HVAC and equipment efficiency and alarm-system security and numerous other IOT applications including camera monitoring, voice communications and recognition, pattern recognition, gesture recognition, data transfer, energy management and monitoring, heat maps, etc. as well as demand response load shedding, etc.

The personalized solid-state and/or other lighting system lighting system can include wireless RF and/or IR links, and, in some embodiments, wired and/or PLC connections, and can be controlled by wireless controllers or interpreters such as those disclosed in PCT patent application PCT/US15/12965 filed Jan. 26, 2015 for “Solid State Lighting Systems”, and can be powered by power supplies such as, but not limited to, supplies such as that disclosed in U.S. patent application Ser. No. 13/674,072, filed Jun. 2, 2013 for a “Dimmable LED Driver with Multiple Power Sources”, which are incorporated herein by reference for all purposes. The solid state luminaire lighting system can include or be based on embodiments disclosed in PCT patent application PCT/US16/69054, filed Dec. 28, 2016 for “Personalized Lighting Systems”, which is incorporated herein by reference for all purposes. Embodiments of the present invention can, in general, include one or more of wired, wireless, powerline control including either or both AC and/or DC powerline control. As discussed herein, the light source, lamp, luminaire, etc. can for example but not limited to be fastened, connected, clamped, and/or affixed to cubical walls or cubicle tops. Embodiments of the present invention can apply principles of light reflection or direct illumination and can use, for example, but not limited to modular design such that luminaire can be parallel or serially or combinations of both to connect to other luminaire, lamp, light source modules and occupy a range of spans across cubical walls. The direction of illumination can either be upward (usually for ambient or safety lighting) or downward (for functional or task lighting) and can be manually, automatically, remotely, etc., combinations of these, etc. activated, set, sequenced, programmed, etc., as needed, desired, required, etc. Edge-lit, OLED, reflective surfaces, direct, indirect, parabolic, reflected, diffused, etc. optical lighting techniques, technologies, approaches, etc. can be used in various embodiments and implementations of the present invention. Embodiments of the present invention can, for example but not limited to be directly fastened to cubical structure(s) configuration and/or indirectly fastened, including but not limited to suspension configuration, using posts, wherein the fixture is fastened to posts or other means of suspension or connection Embodiments of the present invention can be height-adjustable or allow adjustment to optimally illuminate spaces based on varying spatial dimensions, including but not limited to cubicle wall heights, work surfaces, other needs for illumination, etc. Embodiments of the present invention can have sensors that can be attached to the fixture or separate, including but not limited to cubicle walls, work surfaces, computer monitors, keyboards or other computer controls, chairs, under-table, or floors Embodiments of the present invention can be attached to structures using magnetic, gravity, temporary or permanent adhesive, welding, permanent attachment, or mechanical including but not limited to screws, bolts, tension clips, spring clips, or wedge attachments means, etc., combinations of these, etc. Embodiments of the present invention can also be a flat panel and/or use edge-lighting, reflectance, fiber optics, light pipes, etc., or other technologies enabling a thin form factor, etc., combinations of these, etc.

Embodiments of the present invention can be of a variety of form factors to allow attachment to and/or interaction with cabinets, shelves, electronics, cubicle walls, office walls, furniture, or other elements, components, etc. attached to or within the cubicle and/or office space.

Embodiments of the present invention can have independent but coordinated modular control and can also in some implementations of the present invention interface, or connect with ceiling-based or task-based lighting wired and/or wirelessly and/or by PLC.

Embodiments of the present invention provide a higher degree of personalized control over the lighting and other related functions, systems, components, operations, including but not limited to HVAC, acoustics, entertainment, infotainment, other environmental controls, etc., combinations of these, etc. in an individual's environment.

Implementations of the present invention can integrate with a variety of controls, from dedicated hardware controls (e.g., dimmer switch) to mobile devices, computers, remote software and servers, and building management systems including but not limited to the ability to integrate with a variety of sensors, including but not limited to daylight harvesting, motion, temperature, carbon dioxide, etc. cameras, surveillance, security, IOT, others discussed herein, combinations of these, etc. The present invention also can integrate with databases, timers, and clocks to, for example but not limited to, allow color tuning over time in the correct time zone, scheduled performance, responses, etc. The present invention can even (i.e., make uniform) light output on a work surface (higher light output for farthest portion of surface) so that all parts of the surface have equal light output and also employ other forms of optical engineering to achieve this.

The present invention, although described in some ways primarily for occupancy, vacancy, proximity, and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

Some embodiments include RFID or other identification of authorized persons, such as, but not limited to, workers, employees, facilities personnel and managers, first responders such as police, fire department personnel, paramedics, nurses, doctors, other emergency personnel, etc. Embodiments of the present invention can use, for example, but not limited to, RFID worn by individuals to identify and select settings including but not limited to, lighting settings and priorities, hierarchies, etc., combinations of these, etc. based on the individual/personal/etc. RFIDs to, for example, respectively set, turn on, dim, turn off, etc. certain lighting (levels), etc. as well as other settings and functions such as entertainment (radio, music. TV, etc.) settings, bed settings, alert settings which could also be coupled to the time of day, day of the week, weather, ambient temperature, ambient lighting, etc., combinations of these, etc. As a non-limiting example, when a person with a certain profile enters a room, certain lights will turn on to a certain preset level, when a different person with a different profile and potentially different permission levels enters the same room, the light levels may be set to change to a different value or values, when a custodial service member enters the room, the lights may be set to a different level, color temperature, color or colors, etc. including depending on the time or day (or night). The lights and other items can also respond to an emergency including flashing or becoming brighter, more intense, changing color. Embodiments of the present invention can also respond to different priority levels, authority levels, emergencies, personnel, etc.

Some embodiments use proximity and/or signal strength to decide, for example, but not limited to turn on or off lights, etc.

Some embodiments flash lights at the end of an allotted time, for example to indicate that the next group is ready to use, for example, a conference room.

Some embodiments listen for and respond to emergency sounds such as smoke, fire, CO, etc. detectors, sensors, etc. by flashing, turning on, forwarding the information, alert, alarm, etc.

Some embodiments are powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, Zwave, Bluetooth, BTLE. WiFi, sub-gigahertz, cellular, mobile, ISM, Wink, powerline, etc., combinations of these, etc.

Some embodiments of the present invention can interact, support, control, be controlled by social media including but not limited to Facebook, Twitter, Snapshot, Yelp, Next Door, Angie's List, You Tube, LinkedIn, Flickr, Tumblr, e-mail, etc., combinations of these, etc. Embodiments of the present invention can also recognize the siren/alarm of a smoke detector, carbon monoxide detector, etc., combinations of these, etc.

Some embodiments of the present invention can use weight sensors for example, put below a chair, on the seat of a chair, on one or more of the arms of a chair, etc., combinations of these to sense the presence of one or more people in a room to keep the lights on. Implementations of such a sensor can also be used to differentiate between a dead load of, for example, but not limited to books, weights, boxes, etc. by detecting minute movements, etc. associated with persons as well as other methods, techniques, etc. as well as being coupled with other sensor and detector technologies, etc. As one example, a signal could be sent out when a person sits in a seat of a chair and another when the person leaves the seat. Also, signals could be sent out if a person rotates the seat of a chair, tilts the chair, etc., combinations of these, etc.

Some embodiments of the present invention can use face and/or gesture recognition to turn on the lights, dim the lights, etc.

Some embodiments of the present invention can use a T8 body that is necked down/reduced at either end to fit into a T5 socket and provide equivalent light as, for example, but not limited to, a F28 or F54 HO T5 fluorescent lamp.

Some embodiments of the present invention can use a current limiter that can be put in-line with the AC power connections should the ballast fixture be converted from ballast power to AC power so as to limit, switch off, regulate. etc. the AC current fed to the AC TLED and, also in the event that a fluorescent tube was accidentally/mistakenly put in place of the AC TLED or TSSL, etc. the current to the fluorescent tube would be limited/set to a safe maximum level that would not result in danger or harm to the fluorescent lamp, personnel, other equipment and fixtures, etc.

Some embodiments of the present invention include LEDs. OLEDs, QDs, other SSL lighting sources, other light sources, etc. that can be used for marker, tracer, etc. bullet and related applications. Such a light source can be powered for example, by capacitors, super capacitors, etc. that are connected upon firing of the bullet or related projectiles, etc. Embodiments of the present invention can also be powered by generators consisting of coils of wires and for example, but not limited to, magnetics, electromagnetics that could, for example, but not limited to, be powered/turned/rotated, translated, moved, etc., combinations of these, etc. by air flow that is channeled through the bullet and/or projectile as it transverses through the air after being ejected from the gun/cannon/weapon/other source of weapons, etc. The SSL or other lighting can be white light, one or more of white color temperature light(s), one or more color light(s), etc., combinations of these, and can either be fixed or selectable including locally, remotely, wirelessly, set at time of manufacture, fabrication, etc. Any and all types of energy harvesting, including combinations of energy harvesting such as mechanical, vibrational, motion, translation, etc. may be used with the present invention. The light sources may emit in the visible, infrared, ultraviolet, or combinations of these, etc. Electrical, mechanical, electromechanical, including but not limited to micro electromechanical systems (MEMS), micro-machining, micro-fabrication, hybrid manufacture and fabrication, 3 D printing, additive printing, additive manufacturing, subtractive manufacturing, combinations of these, etc. may be used in embodiments of the present invention. The present invention can also use heat to electrical conversion, thermoelectric, thermal converters, thermionic converters including but not limited to micro thermionic converters, energy harvesting, thermionic energy harvesting, thermoelectric energy harvesting, etc., vibration to electrical conversion, mechanical to electrical conversion, etc., combinations of these, etc. The present invention can also use incandescent lighting, etc. Some embodiments of the present invention can, for example, but not limited to, use thermal to electrical conversion combined with incandescent lighting.

Some embodiments of the invention can include indoor and/or outdoor motion sensors. The lights and, for example, sensors can have auxiliary ports that allow both control signals and other types of sensors, detectors, features, functions, etc. including, for example, but not limited to, motion, sound, video, vision recognition, pattern recognition, etc., combinations of these, etc. The indoor and outdoor embodiments can be very similar except for weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well-being watches, other wearables, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc. Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as an intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc.

Some embodiments of the invention can be configured, controlled, monitored, etc., from/to smart devices using for example, but not limited to, Apps, laptops, desktops, servers, mobile and/or PDA devices of any type or form, combinations of these, etc.

Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments of the invention can include outdoor motion sensing with smart additional components, accessories, etc. Sense includes weather, including from any source such as a local weather station, personal weather station, web-based weather report, etc. Smart Motion sense can also dim, flash, change intensities, white colors, be color-changing, etc., communicate two or more way, etc., monitor weather locally, regionally, wind factor, have a wind indicator, etc., wind vane, wind generator, etc.

Implementations of the present invention are designed to be a cost-effective and complete solution that provides both forward and backward compatibility which is also ideal for retrofits and can use either wireless or wire (or both) communications.

Implementations of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, etc.

Implementations of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Embodiments of the present invention support and can include color changing, color tuning, etc. lights with numerous ways to interact with the lights.

Embodiments of the present invention can be integrated with video, burglar, fire alarm, etc. components, systems.

Other features and functions include but are not limited to detecting the frequency using a microprocessor, microcontroller, FPGA. DSP, etc. Use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. Embodiments of the present invention removes the requirement that a reference level and a comparison to the reference level is required to detect the amplitude of the waveform

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc.

The present invention can work with all types of communications devices including portable communications devices worn by individuals, walkie-talkie types of devices, etc.

The present invention can use combinations of wireless and wired interfaces to control and monitor; for example for one or more of the cubicle and/or personal lighting and/or one or more linear or other fluorescent replacement for, for example, but not limited to, T4, T5, T8, T9, T10, T12, etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

The present invention can also have one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy. WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

The present invention can have integrated motion sensor as part of the housing and can also use auxiliary motion sensors and can also have integrated light/photocell sensor as well as auxiliary.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth. RFID, WiFi, ZigBee, ZWave, IEEE 801, IEEE 802, ISM, etc. In addition the present invention can be connected to fire alarms, fire alarm monitoring equipment, etc.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention can also accept the output of a fluorescent ballast replacement that is designed and intended for a LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc. In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics. Some embodiments of the present invention may be multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C. PLC, and others discussed in this document, etc. In various embodiments, the control signals can be received and used by the remote fluorescent lamp replacement ballast or by the LED, OLED and/or QD fluorescent lamp replacement or both. Such a Remote Controlled Florescent Ballast Replacement can also support color LED Fluorescent Lamp Replacements including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc. Color-changing/tuning can include, but is not limited to, white color-tuning including the color temperature tuning/adjustments/settings/etc., color correction temperature (CCT), color rendering index (CRI), etc. Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. The ability to change to different colors when using light sources capable of supporting such (i.e., LEDs, OLEDs and/or QDs including but not limited to red, green, blue, amber, white LEDs and/or any other possible combination of LEDs and colors). Embodiments of the present invention has the ability to store color choices, selections, etc. and retrieve, restore, display, update, etc. these color choices and selections when using non-fluorescent light sources that can support color changing. Embodiments of the present invention also have the ability to change between various color choices, selections, and associated inputs to do as well as the ability to modulate the color choices and selections.

A further feature and capability of embodiments of present invention is use of passive or active clear, diffused, color filters and diffusers to produce enhanced lighting effects.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A lighting system comprising:
a solid state luminaire configured to be mounted to provide task lighting to at least one area;
a user interface configured to accept lighting settings for the lighting system; and
a user interface configured to enable at least one of the solid state luminaire and an area light source to be controlled to provide a desired illumination level to a workspace, wherein the solid state luminaire and the area light source both illuminate the workspace.

2. The lighting system of claim 1, wherein the user interface sets a dimming level of the solid state luminaire to provide the desired illumination level.

3. The lighting system of claim 1, wherein the user interface sets a dimming level of the area light source to provide the desired illumination level.

4. The lighting system of claim 3, wherein an overall power consumption by the solid state luminaire and the area light source is reduced by setting the dimming level of the area light source without reducing the desired illumination level to the workspace.

5. The lighting system of claim 3, wherein the area light source comprises a dimmable solid state lamp replacement for a fluorescent lamp fixture.

6. The lighting system of claim 5, further comprising a diffuser mounted adjacent the dimmable solid state lamp replacement.

7. The lighting system of claim 6, wherein the diffuser is mounted to the dimmable solid state lamp replacement by a plurality of clips.

8. The lighting system of claim 7, wherein the plurality of clips each comprise at least two curved arms configured to partially surround the dimmable solid state lamp replacement and a mounting member connected to the at least two curved arms, wherein the mounting member is configured to be attached to the diffuser.

9. The lighting system of claim 8, wherein the mounting member is configured to be attached to the diffuser by an adhesive.
